(19) United States
(12) Patent Application Publication
(10) Pub. No.: US 2024/0129458 A1
(43) Pub. Date: Apr. 18, 2024

(54) TECHNIQUES FOR SUBSAMPLING FOR CROSS COMPONENT PREDICTION IN VIDEO CODING

(71) Applicant: QUALCOMM Incorporated, San Diego, CA (US)

(72) Inventors: Yao-Jen Chang, San Diego, CA (US); Vadim Seregin, San Diego, CA (US); Bappaditya Ray, San Diego, CA (US); Marta Karczewicz, San Diego, CA (US)

(21) Appl. No.: 18/483,891

(22) Filed: Oct. 10, 2023

Related U.S. Application Data
(60) Provisional application No. 63/488,000, filed on Mar. 2, 2023.
(60) Provisional application No. 63/478,318, filed on Jan. 3, 2023.
(60) Provisional application No. 63/385,917, filed on Dec. 2, 2022.
(60) Provisional application No. 63/379,419, filed on Oct. 13, 2022.

(51) Int. Cl. H04N 19/107; H04N 19/117; H04N 19/132; H04N 19/136; H04N 19/176; H04N 19/186; H04N 19/503; H04N 19/593; H04N 19/70

(52) U.S. Cl. CPC H04N 19/107; H04N 19/117; H04N 19/132; H04N 19/136; H04N 19/176; H04N 19/186; H04N 19/503; H04N 19/593; H04N 19/70

(57) ABSTRACT

A method coding video data includes receiving a block of video data, wherein chroma samples of the block of video data are subsampled relative to luma samples of the block of video data (e.g., 4:2:0 or 4:2:2 video content). A video coder may determine a subsampling technique, from a plurality of subsampling techniques, for the luma samples of the block of video data for a cross-component prediction mode, and may code the block of video data using the subsampling technique and the cross-component prediction mode. A first subsampling technique of the plurality of subsampling techniques includes not applying subsampling to the luma samples of the block of video data, and a second subsampling technique of the plurality of subsampling techniques includes a combination of downsampling filters to be applied to the luma samples of the block.

This application claims the benefit of U.S. Provisional Patent Application No. 63/379,419, filed Oct. 13, 2022, U.S. Provisional Patent Application No. 63/385,917, filed Dec. 2, 2022, U.S. Provisional Patent Application No. 63/478,318, filed Jan. 3, 2023, and U.S. Provisional Patent Application No. 63/488,000, filed Mar. 2, 2023, the entire content of each of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for coding video data using cross-component prediction mode. In general, a video coder may be configured to predict chroma samples from one or more reconstructed luma samples when coding a block of video data using a cross-component prediction mode. In some examples, the luma and chroma samples of the video data may a chroma subsampling format where two or more pixel locations share the same chroma sample value. However, each pixel has a single luma sample value. As such, there are more luma samples than chroma samples for some pictures of video data.

This disclosure describes techniques for determining a subsampling technique to use for luma samples of the block of video data when coding the block according to a cross-component prediction mode. In some examples, the subsampling technique is to not apply subsampling to the luma samples. As such, a prediction model for a cross-component prediction mode may be configured to use multiple luma samples to predict a single chroma sample value. By not subsampling the luma samples, more detail of the luma samples is retained, thus resulting in more accurate chroma prediction, particularly for video content with sharp detail, such as graphics and screen content.

In other examples of the disclosure, a video coder may be configured to code a block of video data using a cross-component prediction mode by applying a combination of downsampling filters to the luma samples of the block of video data to produce downsampled luma samples. The video coder may predict the chroma samples of the block using the downsampled luma samples as inputs to a prediction model having a prediction model shape. In some examples, the downsampling filters used may be based on the prediction model shape. In this way, coding efficiency may be increased and/or distortion may be decreased.

In one example, this disclosure describes a method of decoding video data, the method comprising receiving a block of video data, wherein chroma samples of the block of video data are subsampled relative to luma samples of the block of video data, determining a subsampling technique, from a plurality of subsampling techniques, for the luma samples of the block of video data for a cross-component prediction mode, and decoding the block of video data using the subsampling technique and the cross-component prediction mode.

In another example, this disclosure describes an apparatus configured to decode video data, the apparatus comprising a memory, and one or more processors coupled to the memory, the one or more processors configured to receive a block of video data, wherein chroma samples of the block of video data are subsampled relative to luma samples of the block of video data, determine a subsampling technique, from a plurality of subsampling techniques, for the luma samples of the block of video data for a cross-component prediction mode, and decode the block of video data using the subsampling technique and the cross-component prediction mode.

In another example, this disclosure describes an apparatus configured to decode video data, the apparatus comprising means for receiving a block of video data, wherein chroma samples of the block of video data are subsampled relative to luma samples of the block of video data, means for determining a subsampling technique, from a plurality of subsampling techniques, for the luma samples of the block of video data for a cross-component prediction mode, and means for decoding the block of video data using the subsampling technique and the cross-component prediction mode.

In another example, this disclosure describes a non-transitory computer-readable storage medium storing instructions that, when executed, case one or more processors of a device configured to decode video data to receive a block of video data, wherein chroma samples of the block of video data are subsampled relative to luma samples of the block of video data, determine a subsampling technique, from a plurality of subsampling techniques, for the luma samples of the block of video data for a cross-component prediction mode, and decode the block of video data using the subsampling technique and the cross-component prediction mode.

In another example, this disclosure describes a method of encoding video data, the method comprising receiving a block of video data, wherein chroma samples of the block of video data are subsampled relative to luma samples of the block of video data, determining a subsampling technique, from a plurality of subsampling techniques, for the luma samples of the block of video data for a cross-component prediction mode, and encoding the block of video data using the subsampling technique and the cross-component prediction mode.

In another example, this disclosure describes an apparatus configured to encode video data, the apparatus comprising a memory, and one or more processors coupled to the memory, the one or more processors configured to receive a block of video data, wherein chroma samples of the block of video data are subsampled relative to luma samples of the block of video data, determine a subsampling technique, from a plurality of subsampling techniques, for the luma samples of the block of video data for a cross-component prediction mode, and encode the block of video data using the subsampling technique and the cross-component prediction mode.

In another example, this disclosure describes an apparatus configured to encode video data, the apparatus comprising means for receiving a block of video data, wherein chroma samples of the block of video data are subsampled relative to luma samples of the block of video data, means for determining a subsampling technique, from a plurality of subsampling techniques, for the luma samples of the block of video data for a cross-component prediction mode, and means for encoding the block of video data using the subsampling technique and the cross-component prediction mode.

In another example, this disclosure describes a non-transitory computer-readable storage medium storing instructions that, when executed, case one or more processors of a device configured to encode video data to receive a block of video data, wherein chroma samples of the block of video data are subsampled relative to luma samples of the block of video data, determine a subsampling technique, from a plurality of subsampling techniques, for the luma samples of the block of video data for a cross-component prediction mode, and encode the block of video data using the subsampling technique and the cross-component prediction mode.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 illustrates a reconstructed neighbor area for luma and chroma samples relative to a current block.

FIG. 3 illustrates an example diamond 3×3 model shape for subsampling.

FIG. 4 illustrates an example of classifying neighbor samples in two groups for multi-model linear mode prediction mode.

FIG. 5 illustrates an example effect of a slope adjustment parameter for a cross-component linear model.

FIG. 6 illustrates an example 4×2 subsampling filter.

FIG. 7 illustrates example elongated prediction model shapes.

FIG. 8 illustrates an example 5×4 prediction model shape.

FIG. 9 illustrates example one-directional prediction model shapes.

FIG. 10 illustrates example gradient downsampling filters.

FIG. 11 illustrates example samples and their locations for a 3×3 filter shape.

FIG. 12 illustrates example samples and their locations used for non-linear derivation in a 3×2 prediction model shape.

FIG. 13 illustrates example samples and their locations used for non-linear derivation in a 3×3 prediction model shape.

FIG. 14 is illustrates example non-adjacent neighbor samples for deriving cross-component prediction models.

FIG. 15 is a block diagram illustrating an example video encoder that may perform the techniques of this disclosure.

FIG. 16 is a block diagram illustrating an example video decoder that may perform the techniques of this disclosure.

FIG. 17 is a flowchart illustrating an example method for encoding a current block in accordance with the techniques of this disclosure.

FIG. 18 is a flowchart illustrating an example method for decoding a current block in accordance with the techniques of this disclosure.

FIG. 19 is a flowchart illustrating another example method for encoding a current block in accordance with the techniques of this disclosure.

FIG. 20 is a flowchart illustrating another example method for decoding a current block in accordance with the techniques of this disclosure.

### DETAILED DESCRIPTION

In general, this disclosure describes techniques for coding video data using cross-component prediction mode. In general, a video coder may be configured to predict chroma samples from one or more reconstructed luma samples when coding a block of video data using a cross-component prediction mode. In some examples, the luma and chroma samples of the video data may a chroma subsampling format where two or more pixel locations share the same chroma sample value. However, each pixel has a single luma sample value. As such, there are more luma samples than chroma samples for some pictures of video data.

When luma samples are subsampled for use in cross-component prediction, a video coder may be configured to use a filter surrounding the position for which the subsampling is applied. For example, a video coder may use 4×2 filter to derive subsampled luma samples in 4:2:0 format. Such subsampling may smooth the signal, which may be beneficial for some video content, but may not be optimal for other video content (e.g., video content that has sharp detail, such as graphics or screen content). For sharper detailed video content, such as graphics or screen content, smoothing may eliminate or reduce certain patterns and the derived prediction models from such smoothing may be less efficient.

This disclosure describes techniques for determining a subsampling technique to use for luma samples of the block of video data when coding the block according to a cross-component prediction mode. In some examples, the subsampling technique is to not apply subsampling to the luma samples. As such, a prediction model for a cross-component prediction mode may be configured to use multiple luma samples to predict a single chroma sample value. By not subsampling the luma samples, more detail of the luma samples is retained, thus resulting in more accurate chroma prediction, particularly for video content with sharp detail, such as graphics and screen content.

In other examples of the disclosure, a video coder may be configured to code a block of video data using a cross-component prediction mode by applying a combination of downsampling filters to the luma samples of the block of video data to produce downsampled luma samples. The video coder may predict the chroma samples of the block using the downsampled luma samples as inputs to a prediction model having a prediction model shape. In some examples, the downsampling filters used may be based on the prediction model shape. In this way, coding efficiency may be increased and/or distortion may be decreased.

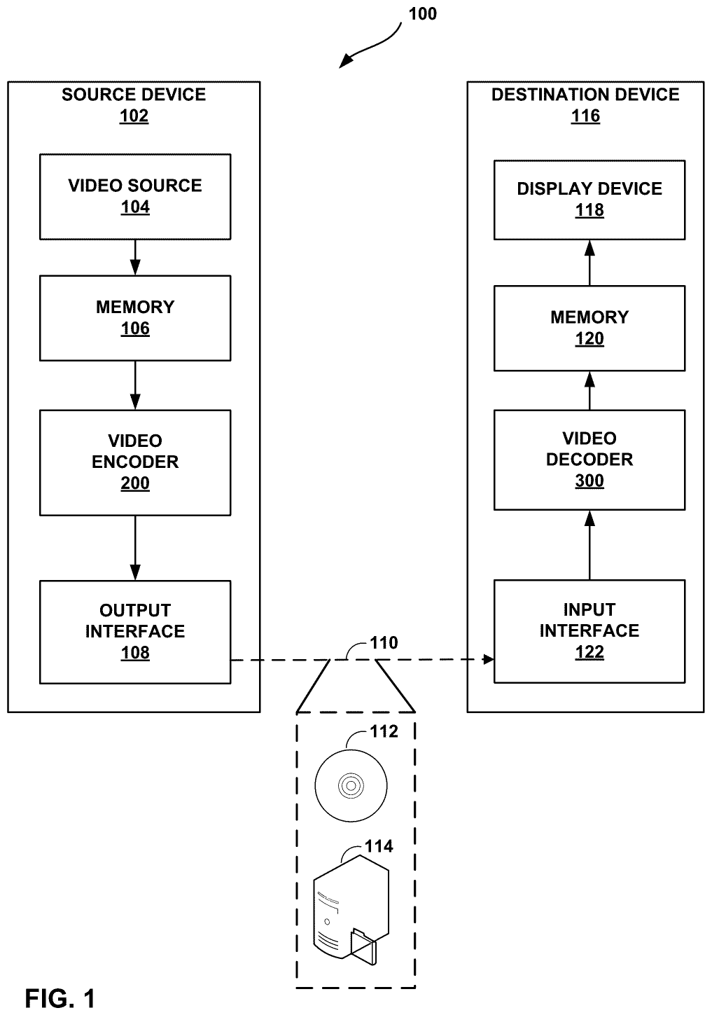

FIG. 1 is a block diagram illustrating an example video encoding and decoding system 100 that may perform the techniques of this disclosure for cross-component chroma prediction. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for subsampling video data for cross-component chroma prediction. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for subsampling video data for cross-component chroma prediction. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use subsampling.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

As will be explained in more detail below, video encoder 200 and video decoder 300 may be configured to perform one or more techniques for determining subsampling techniques and/or prediction models for a cross-component prediction mode. In one example, video encoder 200 and video decoder 300 may be configured to receive a block of video data, wherein chroma samples of the block of video data are subsampled relative to luma samples of the block of video data, determine a subsampling technique, from a plurality of subsampling techniques, for the luma samples of the block of video data for a cross-component prediction mode, and code the block of video data using the subsampling technique and the cross-component prediction mode.

In video codecs such as HEVC and VVC, a commonly used video format is 4:2:0, where the chroma component dimensions are half the sample rate of luma components in the horizontal and vertical directions. Another format that has smaller chroma component dimensions is the 4:2:2 format. The 4:2:0 and 4:2:2 formats are sometimes called chroma subsampling formats.

Chroma subsampling is a method used in image and video compression to reduce the amount of data used to represent a signal. In general, chroma subsampling is based on the principle that the human visual system is less sensitive to variations in color (chroma) than it is to variations in brightness (luma). By reducing the resolution of the chroma channels compared to the luma channel, data savings can be achieved with minimal perceived loss in image quality. In 4:2:0 chroma subsampling, there are four luma samples in a 2×2 grid of pixels, but only two chroma samples of the 2×2 grid (e.g., one Cr and one Cb for the first row of the 2×2 grid). The second row of the 2×2 grid borrows the chroma information of the first row. In 4:2:2 chroma subsampling, there are four luma samples in a 2×2 grid of pixels, but only two chroma samples for each row of the 2×2 grid (e.g., one Cr and one Cb for each row of the 2×2 grid).

When coding video data using a 4:2:2 or 4:2:0 video format, the luma samples may be subsampled to match the chroma block size when cross-component prediction is used. In general, cross-component prediction involves predicting the value of a chroma sample from a corresponding luma sample. Examples of cross-component prediction modes which use such subsampling of luma components may include local illumination compensation (LIC), chroma linear mode, cross-component linear mode (CCLM or LM), multi-model LM (MMLM) mode, convolutional cross-component chroma inter prediction (CCCM), gradient linear model (GLM), among others.

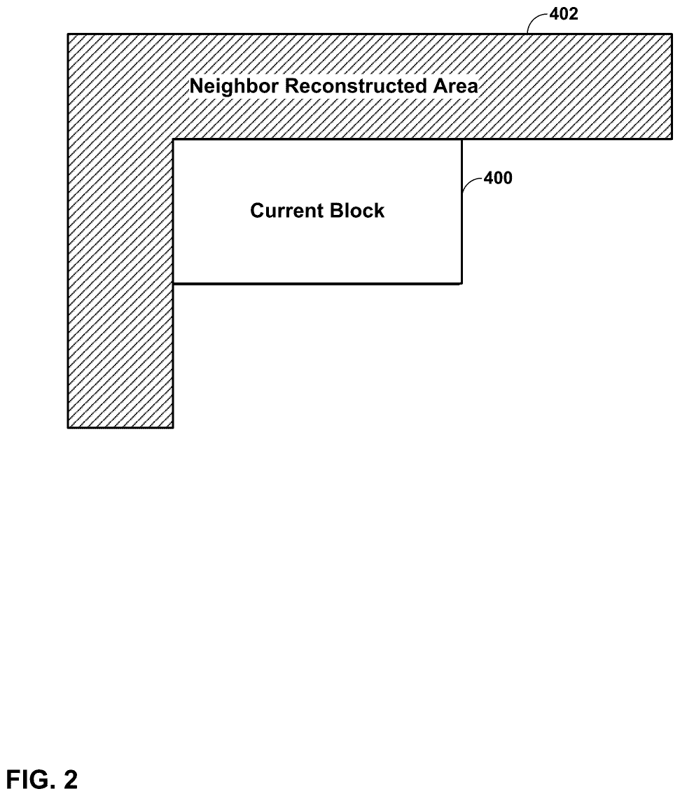

One common part of the above prediction modes is that prediction model parameters (e.g., both linear or non-linear parameters) are derived from the reconstructed neighbor samples between luma and chroma component. For the example of FIG. 2, video encoder 200 and video decoder 300 may be configured to derive model parameters for coding current block 400 from reconstructed samples in neighbor reconstructed area 402 of a picture. Then, video encoder 200 and video decoder 300 apply the derived model to the reconstructed luma samples of current block 400 to derive the prediction of chroma samples for current block 400.

In one example, a linear prediction model may be in the form:

Chroma_prediction=a*Recontructed_luma+b,

where a and b are prediction model parameters, Reconstructed_luma is a corresponding reconstructed luma sample, and Chroma_prediction is the corresponding predicted chroma sample. In another example, a linear prediction model may be represented as:

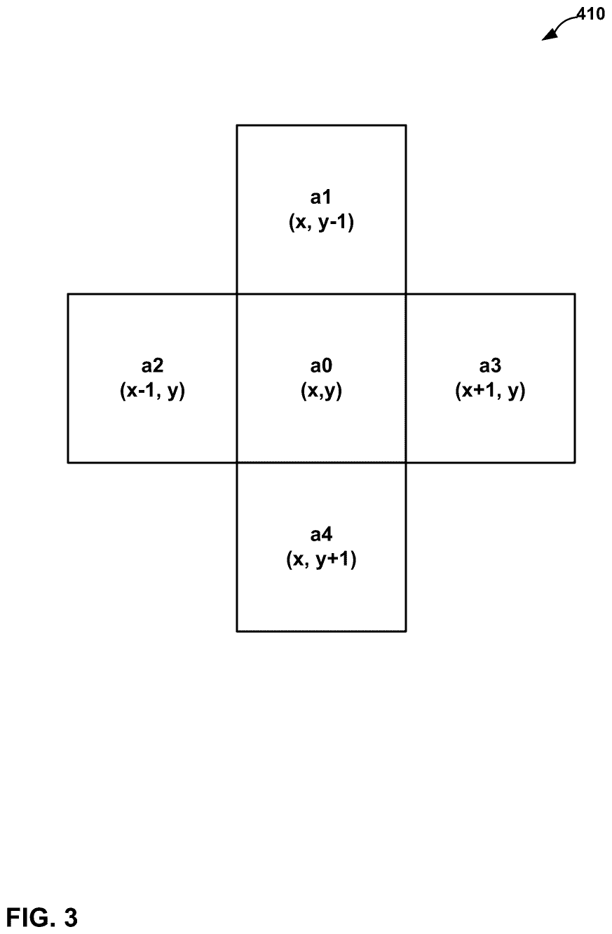

Chroma_prediction=Σᵢaᵢ*Reconstructed_lumaᵢ+b,

where i represents the model shape or filter support, e.g., model shape 401 shown in FIG. 3, of the luma neighborhood, aᵢ and b are the model parameters.

Since luma components have a larger dimension than the chroma components in 4:2:0 and 4:2:2 formats, neighbor luma reconstructed samples are subsampled to derive a prediction model. Reconstructed luma samples of the current block are subsampled as well, in order to apply the subsampled reconstructed luma samples as inputs to the prediction model for chroma prediction derivation.

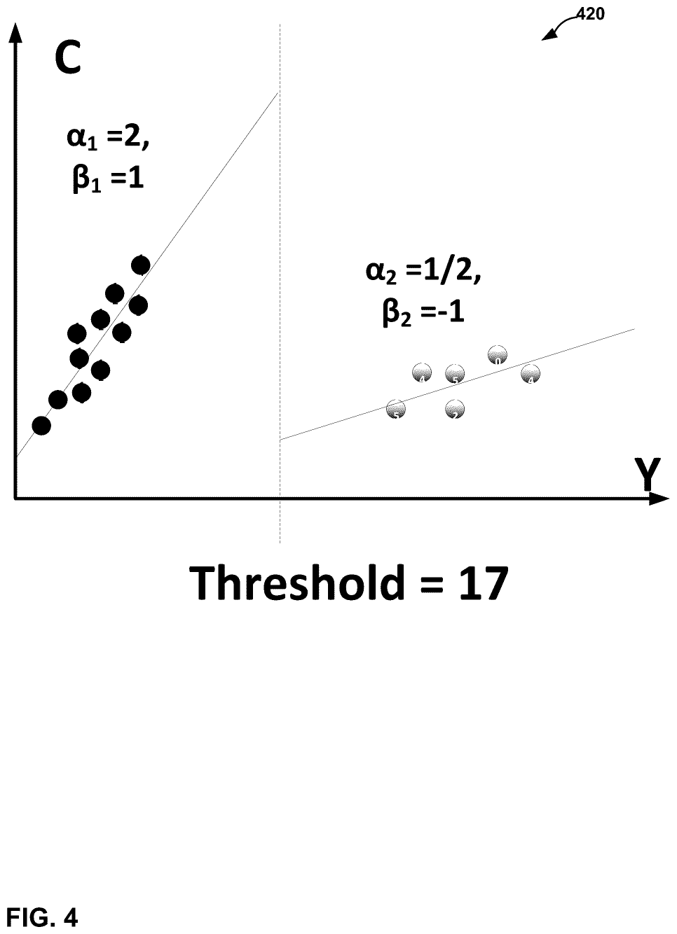

Multi-model LM (MMLM) mode is an example coding mode where two linear models between the luma neighboring reconstructed samples and chroma neighboring reconstructed samples are derived by classifying the sample pairs into two groups using a threshold luma value. The threshold luma value is the average of the luma neighboring reconstructed samples. FIG. 4 shows an example plot 420 where chroma values (C) are predicted using a first set of model parameters (e.g., α₁=2, β₁=1) for luma values (Y) less than the threshold (e.g., 17), and chroma values are predicted using a second set of model parameters (e.g., α₂=1/2, β₂=−1) for luma values greater than the threshold.

In one example, the Enhanced Compression Model (ECM) uses a slope adjustment technique for LM mode and MMLM mode to adjust the slope of the derived linear models as follows: chromaVal=a′ *lumaVal+b′, where a′=a+u, b′=b−u*yᵣ, yᵣ is the average of the reference luma samples, and u is delta value to the slope a. chromaVal is the predicted chroma value and lumaVal is the corresponding luma value.

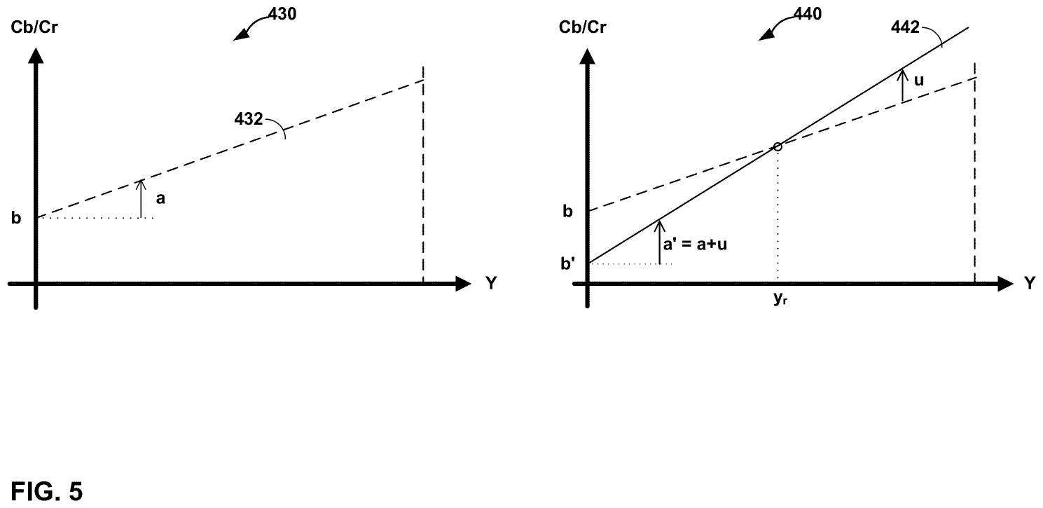

FIG. 5 illustrates an example adjustment of linear model 430 to produce an adjusted linear model 440. The slope of the line 432 of linear model 430 is adjusted to line 442. Delta values, u, may be an integer between −4 and 4, inclusive, and may be signaled in the bitstream. A slope adjustment flag may be signaled to indicate whether to apply the delta value to the slope if one of LM mode and MMLM mode is used.

In one example, cross-component chroma inter prediction (CCCM) uses a 7-tap filter to predict chroma samples from reconstructed luma samples in a similar manner as done by the current CCLM modes. As with CCLM, the reconstructed luma samples are downsampled (or subsampled) to match the lower resolution chroma grid when chroma subsampling is used. Also, similarly to CCLM, there is an option of using a single model or multi-model variant of CCCM. The inputs to the 7-tap filter are listed below:
A center (C, a0) luma sample which is collocated with the chroma sample to be predicted
Above/north (N, a1), below/south (S, a4), left/west (W, a2) and right/east (E, a3) neighbors of the center luma sample as illustrated in FIG. 3.
A nonlinear term P is represented as power of two of the center luma sample C and scaled to the sample value range of the content, i.e., P=(C*C+midVal)>>bitDepth. That is, for 10-bit content it is calculated as: P=(C*C+512)>>10.
The bias term B represents a scalar offset between the input and output (similarly to the offset term in CCLM) and is set to middle chroma value (512 for 10-bit content).
   The output of the filter is calculated as a convolution between the filter coefficients cᵢ and the input values and clipped to the range of valid chroma samples:

predChromaVal=c₀C+c₁N+c₂S+c₃E+c₄W+c₅P+c₆B

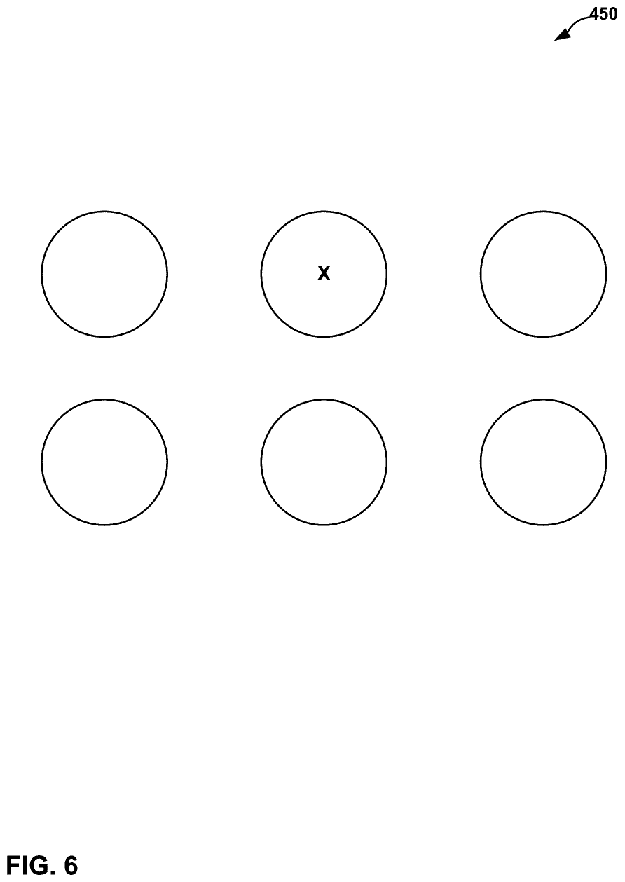

When luma components are subsampled, a video coder may be configured to use a filter surrounding the position for which the subsampling is applied. For example, a video coder may use 4×2 filter 450, shown in FIG. 6, to derive subsampled luma samples in 4:2:0 format (e.g., as in VVC). Such subsampling may smooth the signal, which may be beneficial for some video content, but may not be optimal for other video content (e.g., video content that has sharp detail, such as graphics or screen content). For sharper detailed video content, such as graphics or screen content, smoothing may eliminate or reduce certain patterns and the derived prediction models from such smoothing may be less efficient.

This disclosure describes the following techniques that address one or more of the above-described problems. The techniques of this disclosure described below can be used individually or in any combination. In the examples described below, the techniques of this disclosure may be applied to any cross-component prediction mode where, in one example, reconstructed luma samples are used to derive a chroma prediction in a non 4:4:4 format (e.g., any format that includes chroma subsampling relative to luma). In some examples, the techniques of this disclosure may be applied to LIC, chroma linear mode, CCLM, LM, MMLM, CCCM, GLM, and other similar coding modes.

Changes to Luma Subsampling

To avoid over smoothing, different subsampling or downsampling filters, compared to those described above, may be applied. In the examples below, the terms subsampling and downsampling may be used interchangeably. In general, video encoder 200 and video decoder 300 may be configured to determine a subsampling technique, from a plurality of subsampling techniques, for the luma samples of the block of video data for a cross-component prediction mode. For example, relative to the luma subsampling filters discussed above, video encoder 200 and video decoder 300 may be configured to use a weaker luma filter which takes the neighbor samples with less weights than the center samples when subsampling or smoothing luma samples for a cross-component prediction mode.

In another example, video encoder 200 and video decoder 300 may be configured to not apply luma subsampling to the reconstructed luma samples when coding video data using a cross-component prediction mode. That is, one of the plurality of possible subsampling techniques that video encoder 200 and video decoder 300 may use is to not apply subsampling to the luma samples of the block of video data. In this example, video encoder 200 and video decoder 300 may be configured to derive a prediction model for predicting chroma samples using a larger amount of luma samples compared to the amount of chroma samples. When video encoder 200 and video decoder 300 apply the prediction model to derive the chroma prediction, the prediction model is also applied to nonsubsampled reconstructed luma samples of the current block. In one example, video encoder 200 and video decoder 300 may be configured to not apply luma subsampling when coding screen and graphics content coding using a cross-component prediction mode. In this way, the detail of luma samples is not lost, resulting in better coding efficiency and less distortion in the screen and graphics content.

In some examples, a cross-component prediction mode where no luma subsampling is applied is one of a plurality of cross-component prediction modes. To indicate the use of this mode (i.e., no luma subsampling), video encoder 200 may be configured to encode a flag or index indicating the that the a cross-component prediction mode uses no luma subsampling. Video decoder 300 may receive and decode the flag or index to determine the particular cross-component prediction mode to use.

In one example of the disclosure, video encoder 200 and video decoder 300 are configured to receive a block of video data, wherein chroma samples of the block of video data are subsampled relative to luma samples of the block of video data. Video encoder 200 and video decoder may determine a subsampling technique, from a plurality of subsampling techniques, for the luma samples of the block of video data for a cross-component prediction mode. In one example, video encoder 200 and video decoder 300 may determine to not apply subsampling to the luma samples of the block of video data. That is, not applying subsampling is one of the possible subsampling techniques. In some examples, video encoder 200 and video decoder 300 may determine to not apply subsampling to the luma samples of the block of video data based on the video data being graphics content or screen content.

Video encoder 200 and video decoder 300 may then code (e.g., encode and decode, respectively), the block of video data using the subsampling technique (e.g., no subsampling) and the cross-component prediction mode. In this example, video encoder 200 and video decoder 300 predicts the chroma samples of the block using a prediction model for the cross-component prediction mode that uses a larger number of the luma samples relative to the chroma samples In one example, the prediction model uses a 3×2 filter shape, and video encoder 200 and video decoder 300 may predict one chroma sample of the block using the prediction model using the 3×2 filter shape and six luma samples.

Different Shapes for Prediction Model

In another example of the disclosure, video encoder 200 and video decoder 300 may be configured to use different prediction model shapes for, compared to the techniques described above, when coding video data using a cross-component prediction mode. As described above, in some examples, the prediction mode is in the form of a filter. The downsampled, or not downsampled, luma samples, depending on the subsampling technique determine, are used as inputs to the prediction model. Example prediction model shapes may include diamond 3×3, diamond 5×5, diamond 7×5, square shapes, and others.

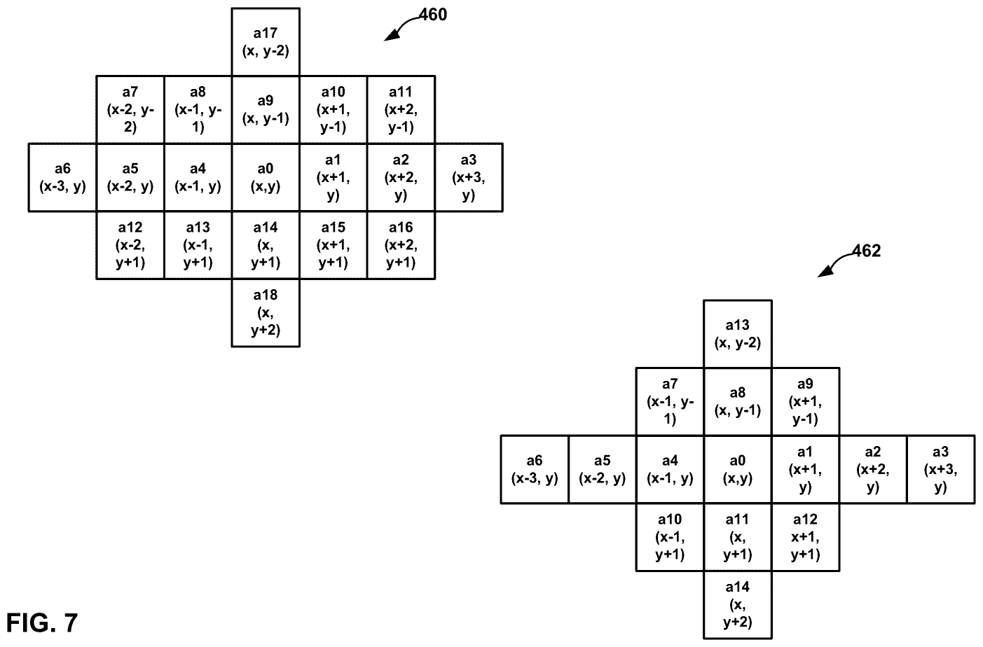

In many instances, objects or camera are moving more in the horizontal direction than in the vertical directions in video content, so more changes in video content may happen in the horizontal direction. To capture this aspect, video encoder 200 and video decoder 300 may be configured to use a prediction model shape that is more elongated in the horizontal direction relative to the vertical direction. For example, if the prediction model is represented as a filter, the filter shape for the prediction model may have more taps horizontally than vertically. FIG. 7 shows examples of an elongated horizontal prediction model shape 460 and 462, where (x,y) are the luma positions and ‘aᵢ’ are the model parameters.

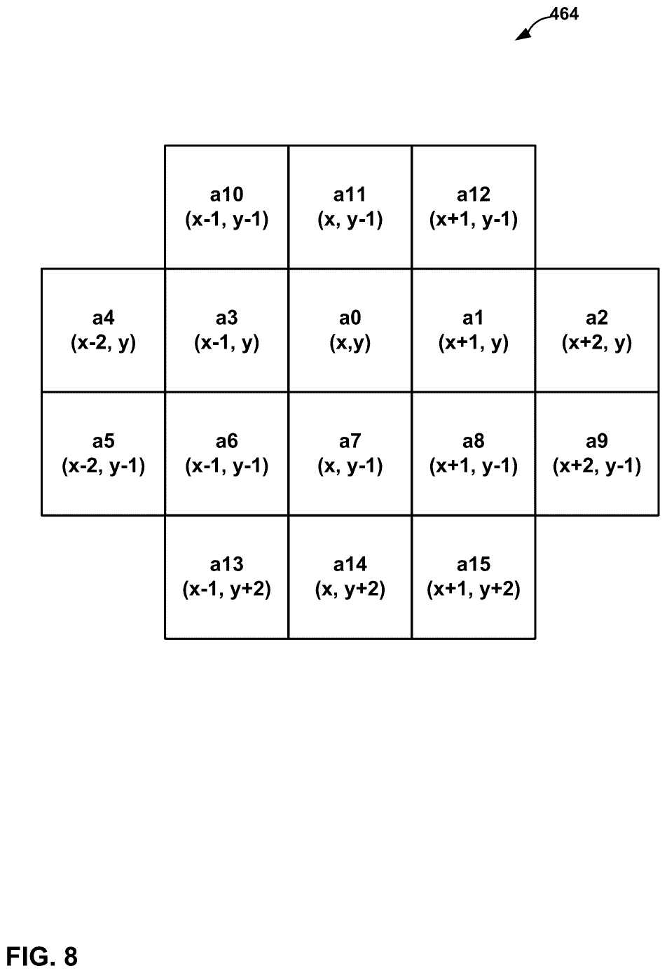

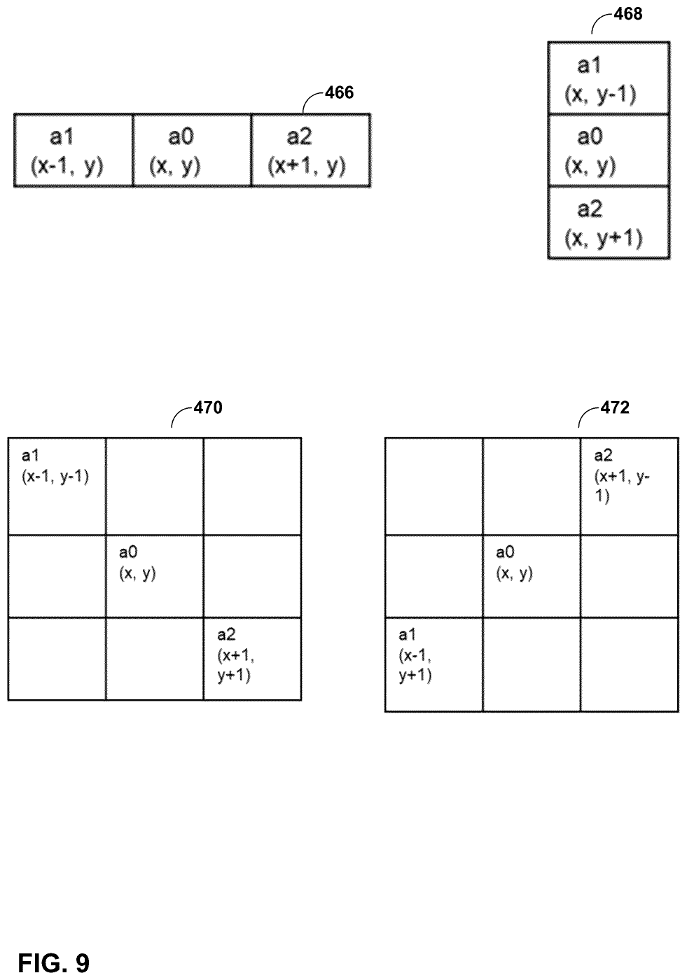

Additionally, the prediction model shape may be nonsymmetrical in some examples. An example of a 5×4 prediction model shape 464 is shown in FIG. 8. Examples of one-directional prediction model shapes are shown in FIG. 9. FIG. 9 shows a horizontal 1×3 prediction model shape 466, a vertical 3×1 prediction model shape 468, a top-left to bottom-right diagonal prediction model shape 470, and a top-right to bottom-left diagonal prediction model shape 472.

The order in which neighboring samples are included in the prediction model, e.g. an index i of the model parameter, may not be important (e.g., may be arbitrary) as long as video encoder 200 and video decoder 300 include those samples in the same order. The inputs of the filter (e.g., the prediction model) may be downsampled luma reconstructed samples. In another example, the inputs of filter are luma samples (or chroma samples) without downsampling.

Various filters (e.g., subsampling or downsampling filters) applied to the luma samples can be combined together to form the input to the prediction mode used for chroma prediction in a cross-component prediction mode. In one example, the combination of filters may be a linear combination of those various filters (e.g., downsampling filters) with the coefficients implicitly derived or signaled. In one example, video encoder 200 and video decoder 300 may perform implicit coefficient derivation using already reconstructed luma and chroma neighboring samples. For example, video encoder 200 and video decoder 300 may minimize the difference between the reconstructed chroma samples and the prediction neighbor chroma samples using the prediction model with one or more (downsampling) filters applied to the reconstructed luma samples. The linear combination of the one or more (downsampling) filters can be applied to luma samples corresponding to the specific chroma shape of the prediction model used for the cross-component prediction mode. In one example, the prediction model shape can be a one-directional shape, as shown in FIG. 9, and the luma samples corresponding to a0, a1, and a2 are applied with the linear combination of the one or more (downsampling) filters.

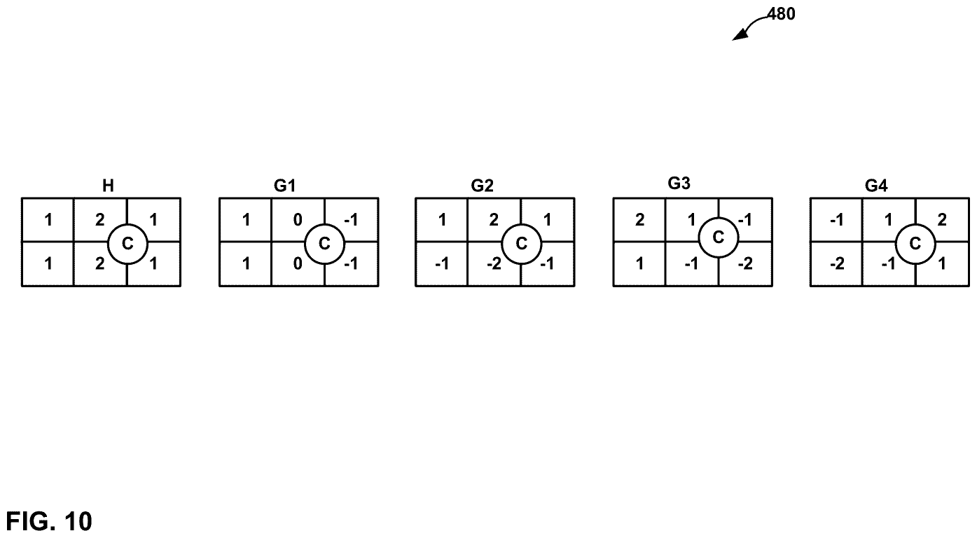

In one example, the downsampling filters can be one or more of the 3×2 downsampling filters 480, e.g., H, G1, G2, G3, and G4, as shown in FIG. 10. In FIG. 10, the filter sample location relative to the currently filtered sample (C) and the filter coefficients is illustrated. Note that G1, G2, G3 and G4 are the gradient filters along one of the horizontal, vertical, and diagonal directions. In general, when predicting chroma sample from luma samples in cross-component prediction mode, video encoder 200 and video decoder 300 may be configured to use a combination of filters (e.g., corresponding to a combination of prediction shapes) that are applied to the luma samples.

There are many alternatives for combining prediction model shapes with different subsampling techniques. In one example, video encoder 200 and video decoder 300 may use downsampled luma samples corresponding to multiple chroma positions as the inputs of a prediction model, and video encoder 200 and video decoder 300 may apply multiple downsampling filters to luma samples for each chroma sample position. Example prediction models may include one or more of the one-directional prediction models shown in FIG. 9.

In other examples, there are two or more different downsampling filters separately applied to luma samples at multiple chroma positions, e.g., a0, a1, a2. The two downsampling filters in the above example may be downsampling filter H (see FIG. 10), and a gradient filter (e.g., G1, G2, G3, or G4) which has the same direction as the one-directional prediction model used. For example, gradient filter G1 may be applied for a horizontal prediction model (e.g. prediction model shape 466 of FIG. 9), gradient filter G2 may be applied for a vertical prediction model (e.g., prediction model shape 468 of FIG. 9), gradient filter G3 may be applied for a top-left to bottom-right prediction model (e.g., prediction model shape 470 of FIG. 9), and gradient filter G4 may be applied for a top-right to bottom-left prediction model (e.g., prediction model shape 472 of FIG. 9).

In another example, video encoder 200 and video decoder 300 may operate according to a constraint that specifies that multiple subsampling filters for luma samples may be only applied to the inputs corresponding to a certain group of chroma positions. Example groups of chroma positions may include a center position only, or center and north (e.g., above) positions, etc. Video encoder 200 and video decoder 300 may use the same downsampling filter for the remaining chroma positions.

In another example, video encoder 200 and video decoder 300 are configured to use downsampled luma samples corresponding to the same chroma position as the inputs of the prediction model. In this example, each input may be generated with a different downsampling filter. In one example, the same position, e.g., (x, y), has different downsampling luma samples applied, e.g., H, G1, G2, G3 and G4 as follows: c0*H (x, y)+c1*G1 (x, y)+c2*G2 (x, y)+c3*G3 (x, y)+c4*G4 (x, y), where c0, c1, c2, c3, c4 are weighting factors for each term.

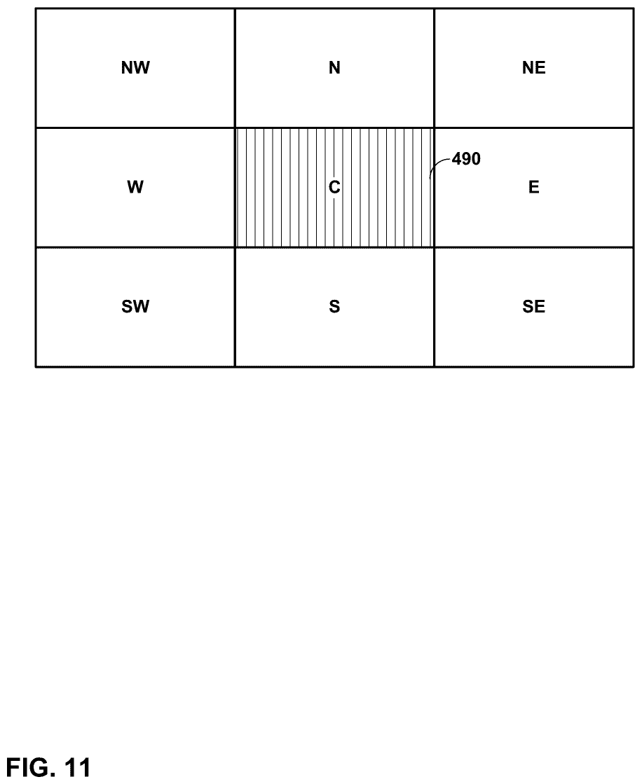

In another example, the inputs of a prediction model are downsampled luma samples corresponding to different gradient predictors, and each gradient predictor is applied with different downsampling luma samples. Note that a gradient predictor could be any predictor difference. Some examples are shown as follows, with the parameters illustrated relative to chroma sample position 490 (C) in FIG. 11:
Gradient predictor 1: (2N+NW+NE)-(2S+SE+SW)
Gradient predictor 2: (2 W+NW+SW)-(2E+SE+NE)
   In this example, NW, N, NE, W, E, SW, S, and SE are luma samples.

In another example, no downsampling filter can be applied to some or all chroma predictors or predictor gradients, and the other downsampling filters can be applied to the same (or some other) chroma predictors or the same (or some other) predictor gradients.

In general, video encoder 200 and video decoder 300 may be configured to code video data using a cross-component prediction mode that uses multiple cross-component prediction models that apply one or more of the different alternatives described above for combining a prediction model shape with different downsampling filters for luma components, including no downsampling (e.g., no subsampling of luma to match the size of chroma).

In another example, the filter shapes for the prediction model may include a nonlinear term(s) and/or a shift term(s) to calculate a final predictor, where the inputs of nonlinear term could be one sample at current position (x, y) or a plurality of samples around the position (x, y). If the direction of a prediction model shape is the same as the direction of the gradient filter in a cross-component model, video encoder 200 and video decoder 300 may be configured to apply the nonlinear terms to the downsampled luma samples in the same direction, and add the non-linear term to the prediction model. The following is an example: c0*H (x, y)+c1*H (x−1, y)+c2*H (x+1, y)+c3*G1 (x, y)+c4*G1 (x−1, y)+c5*G1 (x+1, y)+c6*P(H (x, y))+c7*P(H (x−1, y))+c8*P(H (x+1, y)), where ci are weighting factors for each term, and P(a) is a nonlinear term with ‘a’ as input.

In another example, the prediction model shapes for the prediction model may include a horizontal location (x_c) and a vertical location (y_c) w of the center luma sample (or the center chroma sample), which are calculated with respect to the top-left coordinates of the block. If a prediction model shape is along a specific direction, as shown in FIG. 9, video encoder 200 and video decoder 300 may be constrained such that only one of x_c and y_c is added to the cross-component prediction model.

In one example, if the prediction model has horizontal shape, as shown in prediction model shape 466 of FIG. 9, which is applied with gradient filter G1 of FIG. 10, x_c is added to the model. If the model is vertical prediction shape, as shown in prediction model shape 468 of FIG. 9, applied with gradient filter G2 of FIG. 10, y_c is added to the model. If the model is a diagonal prediction shape, as shown in prediction model shapes 470 or 472 of FIG. 9, applied with gradient filters G3 or G4 of FIG. 10, y_c is added to the model. This example can be used with any of the previous methods described above. One example is that the one-dimensional location is applied with directional nonlinear terms as follows: c0*H (x, y)+c1*H (x−1, y)+c2*H (x+1, y)+c3*G1 (x, y)+c4*G1 (x−1, y)+c5*G1 (x+1, y)+c6*P(H (x, y))+c7*P(H (x−1, y))+c8*P(H (x+1, y))+c9*x_c. where ci are weighting factors for each term, and P(a) is a nonlinear term with ‘a’ as input.

The choice of the prediction model filter shape can be signaled or implicitly derived as detailed below.

The following shows example cross-component models or “modes” for a cross-component prediction mode that use various combination of downsampling filters and prediction models in accordance with the examples described above. Video encoder 200 may be configured to signal a syntax element that indicates the particular component models (e.g., Mode0, Mode1, etc.) to use for a particular cross-component prediction mode. In general, video encoder 200 and video decoder 300 may be configured to determine a cross-component model for the cross-component prediction mode, and then determine the subsampling technique from the cross-component model for the cross-component prediction mode.

Mode0 (filter shape shown in FIG. 2): CCCM

Mode1 (filters shown in FIG. 10): c0*H (x, y)+c1*G1 (x, y)+c2*G2 (x, y)+c3*G3 (x, y)+c4*G4 (x, y), where (x,y) is the position of the luma sample being filtered, and c0-c4 are weighting factors for each term.

Mode2 (filters shown in FIG. 10: c0*H (x, y)+c1*H (x−1, y)+c2*H (x+1, y)+c3*G1 (x, y)+c4*G1 (x−1, y)+c5*G1 (x+1, y)+c6*P(H (x, y))+c7*P(H (x−1, y))+c8*P(H (x+1, y))+c9*x_c+c10*shift, where P(H (x, y))=(H (x, y)\hat{ }2)/1024, and shift=1024/2=512

Mode3 (prediction model shape 468 in FIG. 9): c0*H (x, y)+c1*H (x, y−1)+c2*H (x, y+1)+c3*G1 (x, y)+c4*G1 (x, y−1)+c5*G1 (x, y+1)+c6*P(H (x, y))+c7*P(H (x, y−1))+c8*P(H (x, y+1))+c9*y_c

Mode4 (prediction model shape 468 in FIG. 9): c0*H (x, y)+c1*H (x, y−1)+c2*H (x, y+1)+c3*G1 (x, y)+c4*G1 (x, y−1)+c5*G1 (x, y+1)+c6*P(H (x, y))+c7*P(H (x−1, y))+c8*P(H (x+1, y))+c9*y_c

In summary, in a further example of the disclosure, as opposed to determining that the subsampling technique includes no subsampling, video encoder 200 and video decoder 300 may be configured to determine the subsampling technique to include the application of a combination of downsampling filters, from among a plurality of combinations of downsampling filters, to the luma samples of the block of video data. In some examples, video encoder 200 and video decoder 300 may apply the combination of downsampling filters to the luma samples of the block of video data at multiple chroma sample positions in the block of video data. In other examples, video encoder 200 and video decoder 300 may apply the combination of downsampling filters to the luma samples of the block of video data at particular chroma sample positions in the block of video data according to a constraint.

To code the block of video data using the subsampling technique and the cross-component prediction mode, video encoder 200 and video decoder 300 may apply the combination of downsampling filters to the luma samples of the block of video data to produce downsampled luma samples, and predict the chroma samples of the block using the downsampled luma samples as inputs to a prediction model having a prediction model shape. In some examples, the prediction model includes non-linear terms.

Applying the combination of downsampling filters to the luma samples of the block of video data to produce downsampled luma samples may include applying the combination of downsampling filters to the luma samples of the block of video data at multiple chroma sample positions to produce downsampled luma samples. In other examples, applying the combination of downsampling filters to the luma samples of the block of video data to produce the downsampled luma samples may include applying the combination of downsampling filters to the luma samples of the block of video data based on the prediction model shape to produce the downsampled luma samples.

In some examples, the combination of downsampling filters includes a plurality of 3×2 downsampling filters. The prediction model shape may be one or more of a one-directional shape, a diamond 3×3 shape, a diamond 5×5 shape, a diamond 7×5 shape, or a shape that is larger in a horizontal direction than a vertical direction.

Mode Signaling

Video encoder 200 may be configured to signal the choice of subsampling filter (or no subsampling filter) using a block level flag or syntax element (e.g., an index), a slice level syntax element (e.g., in a slice header), a picture level syntax element (e.g., in a picture header or PPS), or in a sequence level syntax element (e.g., in an SPS or VPS).

In another example, video encoder 200 and video decoder 300 may be configured to derive the block level flag or other level of syntax element without signaling. Multiple variants of a cross-component prediction mode using different subsampling techniques, including no subsampling, may be applied to already reconstructed neighbor luma samples to derive chroma prediction in the reconstructed neighbor area. Since reconstructed neighbor chroma samples are available, the comparison may be performed based on how close the chroma prediction is to the reconstructed neighbor chroma samples, and the cross-component prediction mode variant which has the closest match is chosen and is applied to obtain the chroma prediction for the current block.

In another example, the choices of cross-component prediction mode variants may be ordered according to the cost of how close the match is. Instead of signaling a mode flag or index, a flag or index is signaled to that ordered list of cross-component prediction mode choices. In another way, that ordered list may be treated as a mode flag or mode index predictor. For example, a syntax element is signaled that indicates whether a mode flag is equal to the predictor.

Multiple prediction model shapes may be used in the prediction model. The choice of the shape can be signaled at a block, slice, picture, sequence levels. In one example, the signaling is dependent on the choice of subsampling filter or no subsampling. For example, the choice of the shape is signaled if no subsampling is chosen. In another example, the choice of the shape is implicitly derived using the reconstructed samples in a similar manner as described above for mode signaling using the closest match, where multiple prediction model shapes are evaluated for the reconstructed area and the one with the closest match (or the smallest cost in terms of the difference) is selected.

In another example, the choices of the prediction model shapes may be ordered according to the cost of how close the match is, and instead of signaling a mode shape flag or index, a flag or index is signaled to that ordered list of the shapes. In another way, that ordered list may be treated as a shape flag or shape index predictor.

The choice of subsampling, prediction model shapes, or other cross-component prediction mode variants may be signaled for all cross-component prediction modes, or they can be signaled only for certain cross-component prediction mode variants. For example, CCCM mode may have 3 options: using top and left samples to derive the model, use only top samples to derive the mode, or only using left samples to derive the mode. In one example, the subsampling choice, prediction model shapes or other cross-component prediction mode options may be signaled only for CCCM using top and left samples for mode derivation and are not signaled for other cases. This may provide enough diversity and at the same time save overhead. Similarly, other cross-component prediction modes mentioned above, such as LIC, LM, GLM, etc., may use the same technique.

The same signaling or decoder derived method can be applied to the choice of multiple cross-component models which combine one prediction shape with different subsampling (as mentioned in previous sections).

Non-Linear Terms

In some examples, the prediction model may use non-linear terms. An example of a non-linear term may be a square of reconstructed luma sample divided by a bitdepth. For example, in CCCM mode, a reconstructed luma sample is one and is located in the center of the prediction model shape.

However, having only one non-liner term may not be the optimal choice for all video content. The choice of non-linear terms may depend on subsampling techniques determined, the prediction model shape, and/or other cross-component prediction mode parameters.

In one example, all samples used in the prediction model shape or model filtering may be used to derive the non-linear terms. In other examples, only certain samples may be used for determining non-linear terms, e.g., a center sample, diagonal samples, anti-diagonal samples, samples in one line, samples in one row or column, and other combinations of samples. The choice of the samples to derive the non-linear terms may represent a certain directional property.

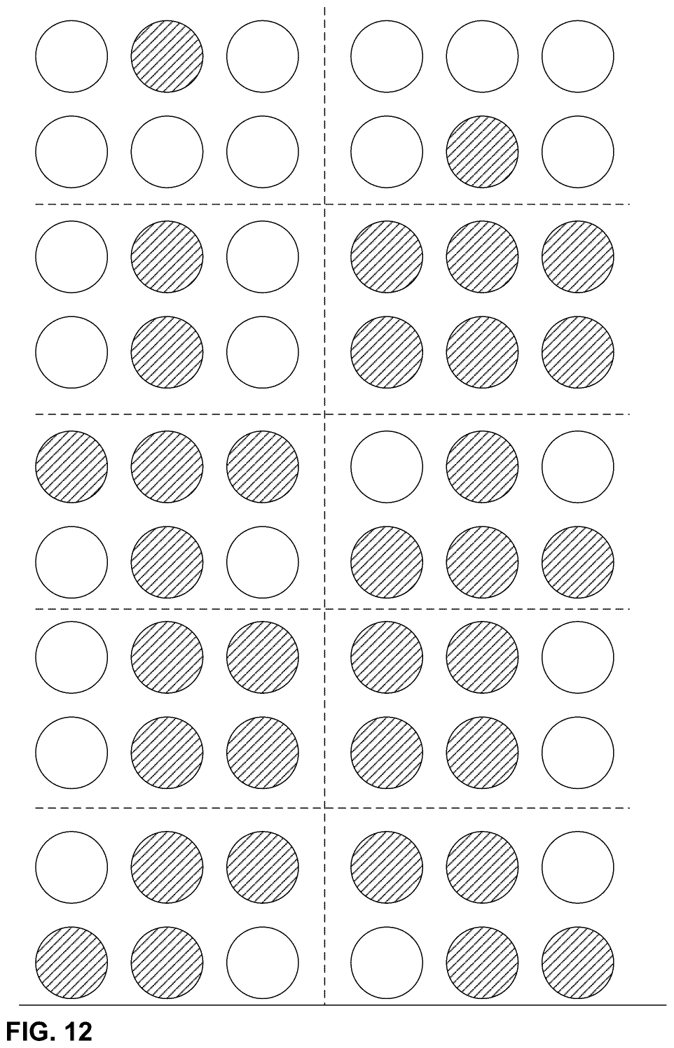

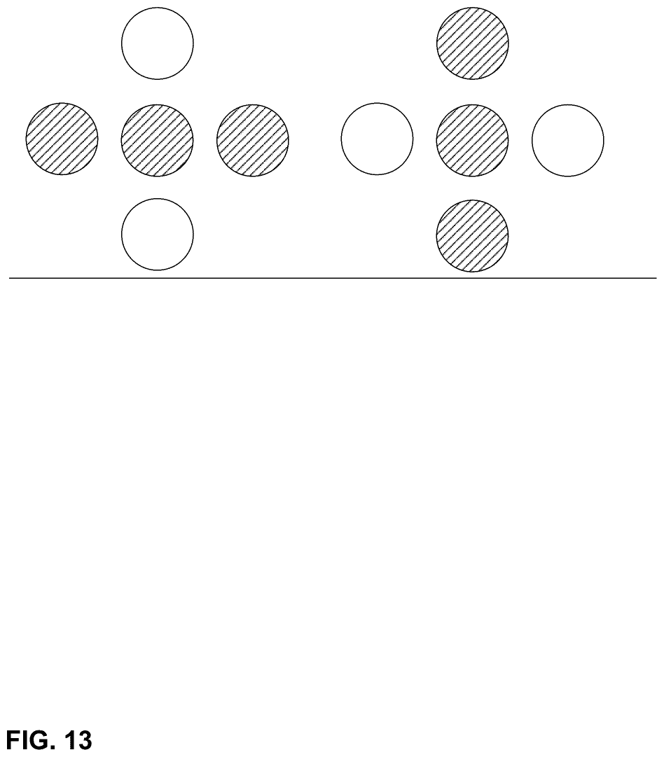

For example, when no subsampling is applied, the 3×2 filter shown in FIG. 6 may be used as the prediction model shape. FIG. 12 and FIG. 13 show other examples of samples used to derive the non-linear terms. In FIGS. 12 and 13, the samples used to derive the non-linear terms are the shaded samples. In another example, a weighted average of multiple samples may be used to derive a non-linear term. The 3×2 prediction model shape 3×2 was used as an example. However, similar multiple non-linear terms techniques including a directionality bias may be used in combination with other prediction model shapes.

Slope Adjustment

In another example, video encoder 200 and video decoder 300 may be configured to add one delta value to a first weight parameter in a prediction model. Take CCCM prediction model as an example. A delta u value is added to the value of weight parameter c₅ of nonlinear term P as follows:

predChromaVal=c₀C+c₁N+c₂S+c₃E+c₄W+(c₅+u)P+c₆B.

In another example, video encoder 200 and video decoder 300 may update a second weight parameter in a prediction model by the derivation with the assumption that predChromaVal is the same when the center (C) luma sample is equal to the average of luma samples in the template (denoted as Cₐᵥₑ). In one example a delta u value is added to the value of weight parameter c₅ of nonlinear term P, and c₀ is updated accordingly as follows:

c₀′Cₐᵥₑ+c₁N+c₂S+c₃E+c₄W+(c₅+u)P+c₆B=c₀Cₐᵥₑ+c₁N+c₂S+c₃E+c₄W+(c₅+u)P+c₆B

Then c₀′=c₀−((u*Cₐᵥₑ+midVal)>>bitDepth).

Explicit signaling may be used to determine whether to enable the slope adjustment for the prediction model, and determine the delta value u. Note that other fixed values may be applied to Cₐᵥₑ to update the second weight parameter in prediction model.

In another example, template-based slope adjustment is proposed. One flag is signaled to determine if the template-based slope adjustment is used for this CU. If it is true, then the template-based SAD costs for each delta index d are calculated, where a delta index d corresponds to a delta value u. Then the best delta index d with the lowest SAD cost is selected for this CU.

Multi-Model Selection

Video encoder 200 and video decoder 300 may use template-based MMLM to determine how many linear models are used in MMLM. One flag may be signaled to determine if the template-based MMLM is used for this CU. If it is true, then the template-based SAD cost for each multi-model index m are calculated, where a multi-model index m corresponds to a value for the number of linear models in MMLM. Then, the best multi-model index m with the lowest SAD cost is selected for this CU.

Non-Adjacent Model

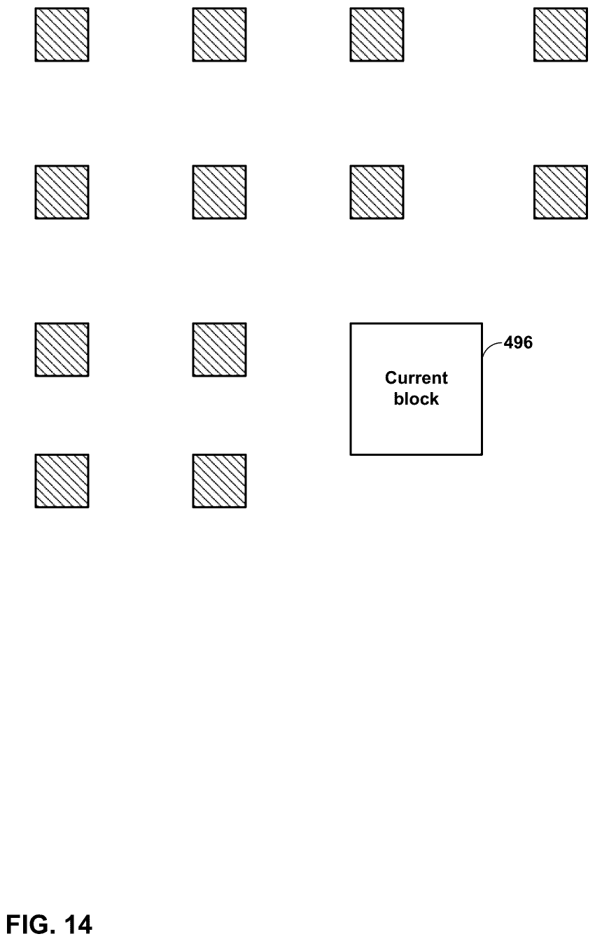

In another example of the disclosure, video encoder 200 and video decoder 300 may derive the cross-component prediction models (CCMs) disclose herein from non-adjacent neighboring samples, as shown in FIG. 14, where the cross-hatched regions around the current block 496 are potential candidate regions which may be used to derive the weighting factors of CCMs. Note that the locations of the regions could be any locations in the picture, and the shape of the regions is not limited to be square.

In one example, a candidate region list is constructed using the available regions in order. A flag is signaled to indicate whether non-adjacent CCP (e.g., cross-component prediction) is applied to the current chroma block. If non-adjacent CCP is applied, an index is signaled to indicate which candidate in the candidate region list is used to derive the prediction model.

In another one example, a candidate list is constructed to add the CCMs using the adjacent neighboring samples first, and then add the CCMs using the non-adjacent neighboring regions later. If a CCM flag is enabled, an index is signaled to indicate which candidate in the list is used to derive the prediction model.

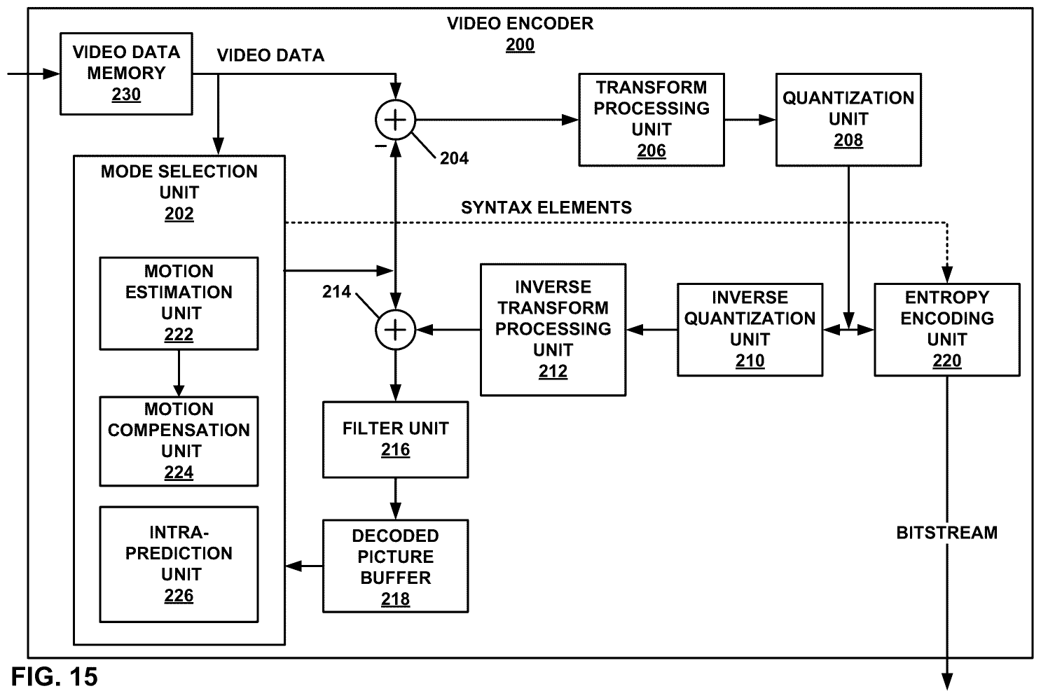

FIG. 15 is a block diagram illustrating an example video encoder 200 that may perform the techniques of this disclosure. FIG. 15 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 15, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 15 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Intra-prediction unit 226 may also configured to encode video data using a cross-component prediction mode, such as LIC, chroma linear mode, CCLM, LM, MMLM, CCCM, GLM, and other similar coding modes, using one or more of the techniques of this disclosure described above.

In one example of the disclosure, intra-prediction unit 226 is configured to receive a block of video data, wherein chroma samples of the block of video data are subsampled relative to luma samples of the block of video data. Intra-prediction unit 226 may determine a subsampling technique, from a plurality of subsampling techniques, for the luma samples of the block of video data for a cross-component prediction mode. In one example, intra-prediction unit 226 may determine to not apply subsampling to the luma samples of the block of video data. That is, not applying subsampling is one of the possible subsampling techniques. In some examples, intra-prediction unit 226 may determine to not apply subsampling to the luma samples of the block of video data based on the video data being graphics content or screen content.

Intra-prediction unit 226 may then encode the block of video data using the subsampling technique (e.g., no subsampling) and the cross-component prediction mode. In this example, intra-prediction unit 226 may predicts the chroma samples of the block using a prediction model for the cross-component prediction mode that uses a larger number of the luma samples relative to the chroma samples.

In a further example of the disclosure, as opposed to determining that the subsampling technique includes no subsampling, intra-prediction unit 226 may be configured to determine the subsampling technique to include the application of a combination of downsampling filters, from among a plurality of combinations of downsampling filters, to the luma samples of the block of video data. To encode the block of video data using the subsampling technique and the cross-component prediction mode, intra-prediction unit 226 may apply the combination of downsampling filters to the luma samples of the block of video data to produce downsampled luma samples, and predict the chroma samples of the block using the downsampled luma samples as inputs to a prediction model having a prediction model shape.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to perform one or more techniques of this disclosure.

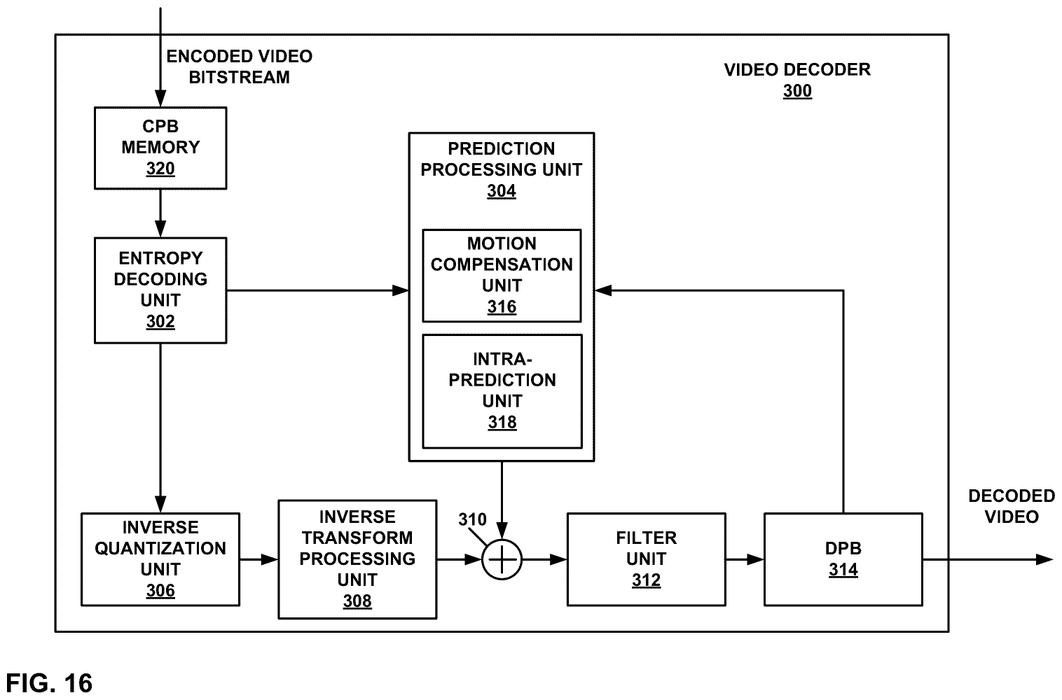

FIG. 16 is a block diagram illustrating an example video decoder 300 that may perform the techniques of this disclosure. FIG. 16 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 16, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

Intra-prediction unit 318 may also configured to decode video data using a cross-component prediction mode, such as LIC, chroma linear mode, CCLM, LM, MMLM, CCCM, GLM, and other similar coding modes, using one or more of the techniques of this disclosure described above.

In one example of the disclosure, intra-prediction unit 318 is configured to receive a block of video data, wherein chroma samples of the block of video data are subsampled relative to luma samples of the block of video data. Intra-prediction unit 318 may determine a subsampling technique, from a plurality of subsampling techniques, for the luma samples of the block of video data for a cross-component prediction mode. In one example, intra-prediction unit 318 may determine to not apply subsampling to the luma samples of the block of video data. That is, not applying subsampling is one of the possible subsampling techniques. In some examples, intra-prediction unit 318 may determine to not apply subsampling to the luma samples of the block of video data based on the video data being graphics content or screen content.

Intra-prediction unit 318 may then decode the block of video data using the subsampling technique (e.g., no subsampling) and the cross-component prediction mode. In this example, intra-prediction unit 318 may predicts the chroma samples of the block using a prediction model for the cross-component prediction mode that uses a larger number of the luma samples relative to the chroma samples.

In a further example of the disclosure, as opposed to determining that the subsampling technique includes no subsampling, intra-prediction unit 318 may be configured to determine the subsampling technique to include the application of a combination of downsampling filters, from among a plurality of combinations of downsampling filters, to the luma samples of the block of video data. To decode the block of video data using the subsampling technique and the cross-component prediction mode, intra-prediction unit 318 may apply the combination of downsampling filters to the luma samples of the block of video data to produce downsampled luma samples, and predict the chroma samples of the block using the downsampled luma samples as inputs to a prediction model having a prediction model shape.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 16 are illustrated to assist with understanding the operations performed by video decoder 300. The units may be implemented as fixed-function circuits, programmable circuits, or a combination thereof. Similar to FIG. 15, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 15).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 15). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to perform one or more techniques of this disclosure.

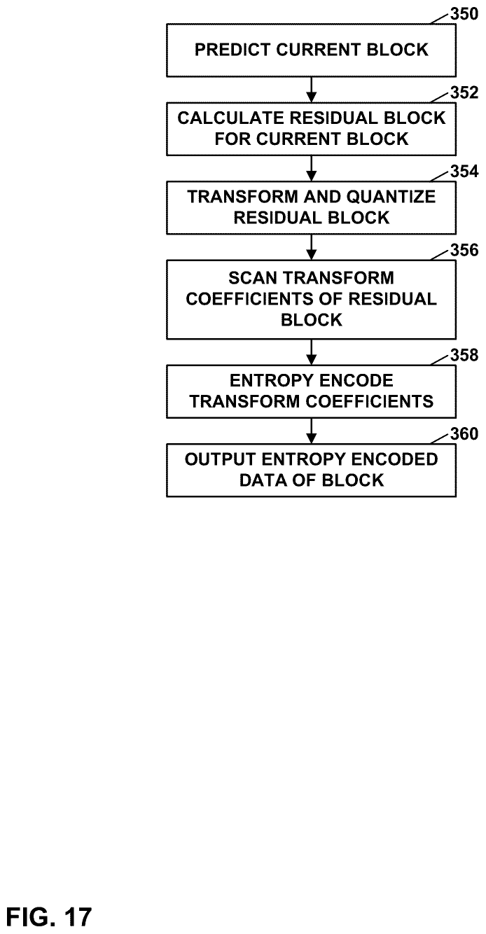

FIG. 17 is a flowchart illustrating an example method for encoding a current block in accordance with the techniques of this disclosure. The current block may be or include a current CU. Although described with respect to video encoder 200 (FIGS. 1 and 15), it should be understood that other devices may be configured to perform a method similar to that of FIG. 17.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

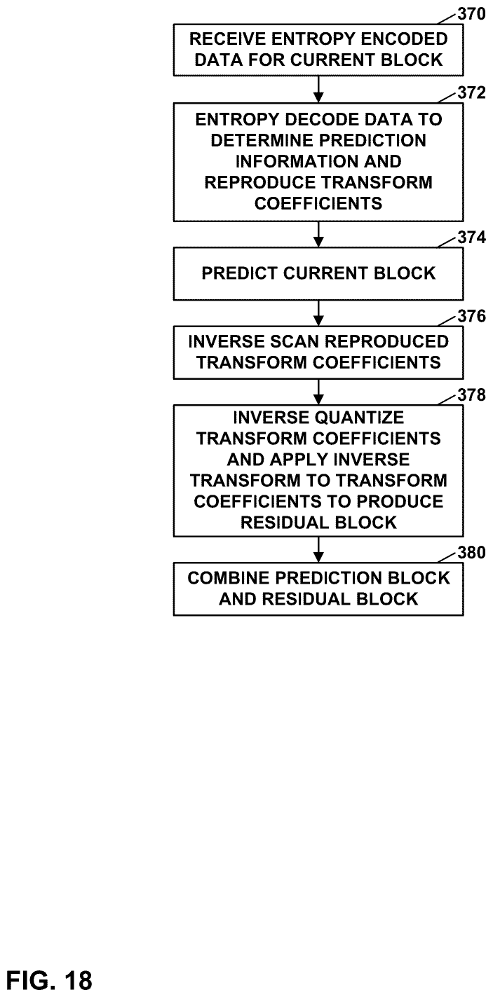

FIG. 18 is a flowchart illustrating an example method for decoding a current block of video data in accordance with the techniques of this disclosure. The current block may be or include a current CU. Although described with respect to video decoder 300 (FIGS. 1 and 16), it should be understood that other devices may be configured to perform a method similar to that of FIG. 18.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

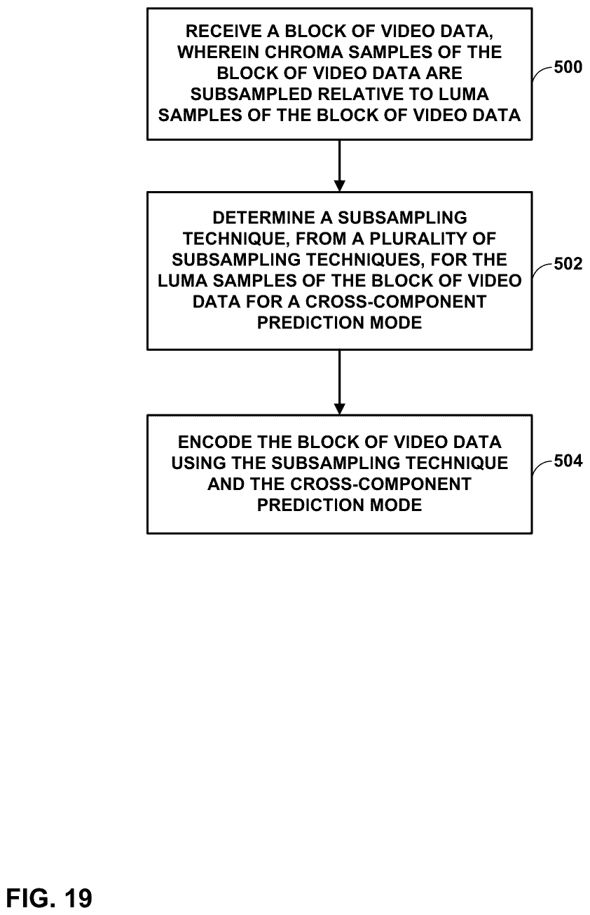

FIG. 19 is a flowchart illustrating another example method for encoding a current block in accordance with the techniques of this disclosure. The techniques of FIG. 19 may be performed by one or more structural units of video encoder 200, including intra-prediction unit 226.

In one example of the disclosure, video encoder 200 may be configured to receive a block of video data, wherein chroma samples of the block of video data are subsampled relative to luma samples of the block of video data (550), determine a subsampling technique, from a plurality of subsampling techniques, for the luma samples of the block of video data for a cross-component prediction mode (552), and encode the block of video data using the subsampling technique and the cross-component prediction mode (554). The cross-component prediction mode may be one of local illumination compensation (LIC), chroma linear mode, cross-component linear mode (CCLM), multi-model LM (MMLM) mode, cross-component chroma inter prediction (CCCM), or gradient linear model (GLM).

In one example, to determine the subsampling technique, video encoder 200 is configured to determine to not apply subsampling to the luma samples of the block of video data. To encode the block of video data using the subsampling technique and the cross-component prediction mode, video encoder 200 may be configured to predict the chroma samples of the block using a prediction model for the cross-component prediction mode that uses a larger number of the luma samples relative to the chroma samples. In some examples, the prediction model includes non-linear terms.

In other examples, the prediction model uses a 3×2 filter shape, and to encode ode the block of video data using the subsampling technique and the cross-component prediction mode, video encoder 200 is configured to predict one chroma sample of the block using the prediction model using the 3×2 filter shape and six luma samples.

In another example, to determine to not apply subsampling to the luma samples of the block of video data, video encoder 200 is configured to determine to not apply subsampling to the luma samples of the block of video data based on the video data being graphics content or screen content.

In another example of the disclosure, to determine the subsampling technique, video encoder 200 is configured to determine to apply a combination of downsampling filters to the luma samples of the block of video data. Video encoder 200 may apply the combination of downsampling filters to the luma samples of the block of video data at multiple chroma sample positions in the block of video data. In other examples, video encoder 200 may apply the combination of downsampling filters to the luma samples of the block of video data at particular chroma sample positions in the block of video data according to a constraint. To determine to apply the combination of downsampling filters to the luma samples of the block of video data, video encoder 200 may determine to apply the combination of downsampling filters, from among a plurality of combinations of downsampling filters, to the luma samples of the block of video data.

In other examples, to encode ode the block of video data using the subsampling technique and the cross-component prediction mode, video encoder 200 may apply the combination of downsampling filters to the luma samples of the block of video data to produce downsampled luma samples, and predict the chroma samples of the block using the downsampled luma samples as inputs to a prediction model having a prediction model shape.

To apply the combination of downsampling filters to the luma samples of the block of video data to produce downsampled luma samples, video encoder 200 may apply the combination of downsampling filters to the luma samples of the block of video data at multiple chroma sample positions to produce downsampled luma samples. In another example, to apply the combination of downsampling filters to the luma samples of the block of video data to produce the downsampled luma samples, video encoder 200 may apply the combination of downsampling filters to the luma samples of the block of video data based on the prediction model shape to produce the downsampled luma samples. In one example, the combination of downsampling filters includes a plurality of 3×2 downsampling filters. In a further example, the prediction model shape is a one-directional shape, a diamond 3×3 shape, a diamond 5×5 shape, a diamond 7×5 shape, or a shape that is larger in a horizontal direction than a vertical direction. In other examples, the prediction model includes non-linear terms.

In another example, of the disclosure, to determine the subsampling technique, from the plurality of subsampling techniques, for the luma samples of the block of video data for the cross-component prediction mode, video encoder 200 may be configured to determine a cross-component model for the cross-component prediction mode, and determine the subsampling technique from the cross-component model for the cross-component prediction mode. To determine the cross-component model for the cross-component prediction mode, video encoder 200 may determine the cross-component model for the cross-component prediction mode from non-adjacent neighbor blocks of the block of video data.

In another example, to determine the subsampling technique, video encoder 200 may receive a syntax element that indicates the subsampling technique, wherein a first subsampling technique of the plurality of subsampling techniques includes not applying subsampling to the luma samples of the block of video data, and a second subsampling technique of the plurality of subsampling techniques includes a combination of downsampling filters to be applied to the luma samples of the block.

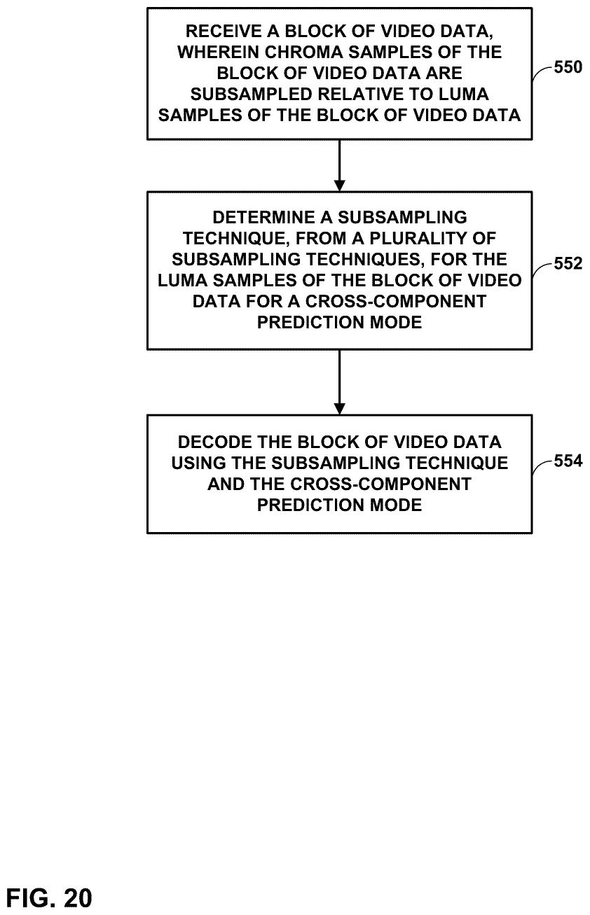

FIG. 20 is a flowchart illustrating another example method for decoding a current block in accordance with the techniques of this disclosure. The techniques of FIG. 20 may be performed by one or more structural units of video decoder 300, including intra-prediction unit 318.

In one example of the disclosure, video decoder 300 may be configured to receive a block of video data, wherein chroma samples of the block of video data are subsampled relative to luma samples of the block of video data (550), determine a subsampling technique, from a plurality of subsampling techniques, for the luma samples of the block of video data for a cross-component prediction mode (552), and decode the block of video data using the subsampling technique and the cross-component prediction mode (554). The cross-component prediction mode may be one of local illumination compensation (LIC), chroma linear mode, cross-component linear mode (CCLM), multi-model LM (MMLM) mode, cross-component chroma inter prediction (CCCM), or gradient linear model (GLM).

In one example, to determine the subsampling technique, video decoder 300 is configured to determine to not apply subsampling to the luma samples of the block of video data. To decode the block of video data using the subsampling technique and the cross-component prediction mode, video decoder 300 may be configured to predict the chroma samples of the block using a prediction model for the cross-component prediction mode that uses a larger number of the luma samples relative to the chroma samples. In some examples, the prediction model includes non-linear terms.

In other examples, the prediction model uses a 3×2 filter shape, and to decode the block of video data using the subsampling technique and the cross-component prediction mode, video decoder 300 is configured to predict one chroma sample of the block using the prediction model using the 3×2 filter shape and six luma samples.

In another example, to determine to not apply subsampling to the luma samples of the block of video data, video decoder 300 is configured to determine to not apply subsampling to the luma samples of the block of video data based on the video data being graphics content or screen content.

In another example of the disclosure, to determine the subsampling technique, video decoder 300 is configured to determine to apply a combination of downsampling filters to the luma samples of the block of video data. Video decoder 300 may apply the combination of downsampling filters to the luma samples of the block of video data at multiple chroma sample positions in the block of video data. In other examples, video decoder 300 may apply the combination of downsampling filters to the luma samples of the block of video data at particular chroma sample positions in the block of video data according to a constraint. To determine to apply the combination of downsampling filters to the luma samples of the block of video data, video decoder 300 may determine to apply the combination of downsampling filters, from among a plurality of combinations of downsampling filters, to the luma samples of the block of video data.

In other examples, to decode the block of video data using the subsampling technique and the cross-component prediction mode, video decoder 300 may apply the combination of downsampling filters to the luma samples of the block of video data to produce downsampled luma samples, and predict the chroma samples of the block using the downsampled luma samples as inputs to a prediction model having a prediction model shape.

To apply the combination of downsampling filters to the luma samples of the block of video data to produce downsampled luma samples, video decoder 300 may apply the combination of downsampling filters to the luma samples of the block of video data at multiple chroma sample positions to produce downsampled luma samples. In another example, to apply the combination of downsampling filters to the luma samples of the block of video data to produce the downsampled luma samples, video decoder 300 may apply the combination of downsampling filters to the luma samples of the block of video data based on the prediction model shape to produce the downsampled luma samples. In one example, the combination of downsampling filters includes a plurality of 3×2 downsampling filters. In a further example, the prediction model shape is a one-directional shape, a diamond 3×3 shape, a diamond 5×5 shape, a diamond 7×5 shape, or a shape that is larger in a horizontal direction than a vertical direction. In other examples, the prediction model includes non-linear terms.

In another example, of the disclosure, to determine the subsampling technique, from the plurality of subsampling techniques, for the luma samples of the block of video data for the cross-component prediction mode, video decoder 300 may be configured to determine a cross-component model for the cross-component prediction mode, and determine the subsampling technique from the cross-component model for the cross-component prediction mode. To determine the cross-component model for the cross-component prediction mode, video decoder 300 may determine the cross-component model for the cross-component prediction mode from non-adjacent neighbor blocks of the block of video data.

In another example, to determine the subsampling technique, video decoder 300 may receive a syntax element that indicates the subsampling technique, wherein a first subsampling technique of the plurality of subsampling techniques includes not applying subsampling to the luma samples of the block of video data, and a second subsampling technique of the plurality of subsampling techniques includes a combination of downsampling filters to be applied to the luma samples of the block.

The following numbered clauses illustrate one or more aspects of the devices and techniques described in this disclosure.

Aspect 1A—A method of coding video data, the method comprising: determining a subsampling filter for luma components of video data for a prediction mode; and coding the video data using the subsampling filter.

Aspect 2A—The method of Aspect 1A, wherein the prediction mode is one of local illumination compensation (LIC), chroma linear mode, cross-component linear mode (CCLM or LM), cross-component chroma inter prediction (CCCM), or gradient linear model (GLM).

Aspect 3A—The method of Aspect 1A, wherein the subsampling filter is no subsampling based on the video data being graphics or screen content.

Aspect 4A—The method of Aspect 1A, wherein the subsampling filter is larger in a horizontal direction than a vertical direction.

Aspect 5A—The method of Aspect 1A, further comprising coding a flag that indicates the subsampling filter.

Aspect 6A—The method of any of Aspects 1A-5A, wherein coding comprises decoding.

Aspect 7A—The method of any of Aspects 1A-5A, wherein coding comprises encoding.

Aspect 8A—A device for coding video data, the device comprising one or more means for performing the method of any of Aspects 1A-7A.

Aspect 9A—The device of Aspect 8A, wherein the one or more means comprise one or more processors implemented in circuitry.

Aspect 10A—The device of any of Aspects 8A and 9A, further comprising a memory to store the video data.

Aspect 11A—The device of any of Aspects 8A-10A, further comprising a display configured to display decoded video data.

Aspect 12A—The device of any of Aspects 8A-11A, wherein the device comprises one or more of a camera, a computer, a mobile device, a broadcast receiver device, or a set-top box.

Aspect 13A—The device of any of Aspects 8A-12A, wherein the device comprises a video decoder.

Aspect 14A—The device of any of Aspects 8A-13A, wherein the device comprises a video encoder.

Aspect 15A—A computer-readable storage medium having stored thereon instructions that, when executed, cause one or more processors to perform the method of any of Aspects 1A-7A.

Aspect 1B—A method of decoding video data, the method comprising: receiving a block of video data, wherein chroma samples of the block of video data are subsampled relative to luma samples of the block of video data; determining a subsampling technique, from a plurality of subsampling techniques, for the luma samples of the block of video data for a cross-component prediction mode; and decoding the block of video data using the subsampling technique and the cross-component prediction mode.

Aspect 2B—The method of Aspect 1B, wherein determining the subsampling technique comprises: determining to not apply subsampling to the luma samples of the block of video data.

Aspect 3B—The method of Aspect 2B, wherein decoding the block of video data using the subsampling technique and the cross-component prediction mode comprises: predicting the chroma samples of the block using a prediction model for the cross-component prediction mode that uses a larger number of the luma samples relative to the chroma samples.

Aspect 4B—The method of Aspect 3B, wherein the prediction model includes non-linear terms.

Aspect 5B—The method of Aspect 3B, wherein the prediction model uses a 3×2 filter shape, and wherein decoding the block of video data using the subsampling technique and the cross-component prediction mode comprises: predicting one chroma sample of the block using the prediction model using the 3×2 filter shape and six luma samples.

Aspect 6B—The method of Aspect 2B, wherein determining to not apply subsampling to the luma samples of the block of video data comprises: determining to not apply subsampling to the luma samples of the block of video data based on the video data being graphics content or screen content.

Aspect 7B—The method of Aspect 1B, wherein determining the subsampling technique comprises: determining to apply a combination of downsampling filters to the luma samples of the block of video data.

Aspect 8B—The method of Aspect 7B, further comprising: applying the combination of downsampling filters to the luma samples of the block of video data at multiple chroma sample positions in the block of video data.

Aspect 9B—The method of Aspect 7B, further comprising: applying the combination of downsampling filters to the luma samples of the block of video data at particular chroma sample positions in the block of video data according to a constraint.

Aspect 10B—The method of Aspect 7B, wherein determining to apply the combination of downsampling filters to the luma samples of the block of video data comprises: determining to apply the combination of downsampling filters, from among a plurality of combinations of downsampling filters, to the luma samples of the block of video data.

Aspect 11B—The method of Aspect 7B, wherein decoding the block of video data using the subsampling technique and the cross-component prediction mode comprises: applying the combination of downsampling filters to the luma samples of the block of video data to produce downsampled luma samples; and predicting the chroma samples of the block using the downsampled luma samples as inputs to a prediction model having a prediction model shape.

Aspect 12B—The method of Aspect 11B, wherein applying the combination of downsampling filters to the luma samples of the block of video data to produce downsampled luma samples comprises: applying the combination of downsampling filters to the luma samples of the block of video data at multiple chroma sample positions to produce downsampled luma samples.

Aspect 13B—The method of Aspect 11B, wherein applying the combination of downsampling filters to the luma samples of the block of video data to produce the downsampled luma samples comprises: applying the combination of downsampling filters to the luma samples of the block of video data based on the prediction model shape to produce the downsampled luma samples.

Aspect 14B—The method of Aspect 13B, wherein the combination of downsampling filters includes a plurality of 3×2 downsampling filters.

Aspect 15B—The method of Aspect 13B, wherein the prediction model shape is a one-directional shape, a diamond 3×3 shape, a diamond 5×5 shape, a diamond 7×5 shape, or a shape that is larger in a horizontal direction than a vertical direction.

Aspect 16B—The method of Aspect 11B, wherein the prediction model includes non-linear terms.

Aspect 17B—The method of Aspect 1B, wherein determining the subsampling technique, from the plurality of subsampling techniques, for the luma samples of the block of video data for the cross-component prediction mode comprises: determining a cross-component model for the cross-component prediction mode; and determining the subsampling technique from the cross-component model for the cross-component prediction mode.

Aspect 18B—The method of Aspect 17B, wherein determining the cross-component model for the cross-component prediction mode comprises: determining the cross-component model for the cross-component prediction mode from non-adjacent neighbor blocks of the block of video data.

Aspect 19B—The method of any of Aspects 1B-18B, wherein determining the subsampling technique comprises: receiving a syntax element that indicates the subsampling technique, wherein a first subsampling technique of the plurality of subsampling techniques includes not applying subsampling to the luma samples of the block of video data, and a second subsampling technique of the plurality of subsampling techniques includes a combination of downsampling filters to be applied to the luma samples of the block.

Aspect 20B—The method of any of Aspects 1B-19B, wherein the cross-component prediction mode is one of local illumination compensation (LIC), chroma linear mode, cross-component linear mode (CCLM), multi-model LM (MMLM) mode, cross-component chroma inter prediction (CCCM), or gradient linear model (GLM).

Aspect 21B—An apparatus configured to decode video data, the apparatus comprising: a memory; and one or more processors coupled to the memory, the one or more processors configured to: receive a block of video data, wherein chroma samples of the block of video data are subsampled relative to luma samples of the block of video data; determine a subsampling technique, from a plurality of subsampling techniques, for the luma samples of the block of video data for a cross-component prediction mode; and decode the block of video data using the subsampling technique and the cross-component prediction mode.

Aspect 22B—The apparatus of Aspect 21B, wherein to determine the subsampling technique, the one or more processors are further configured to: determine to not apply subsampling to the luma samples of the block of video data.

Aspect 23B—The apparatus of Aspect 22B, wherein to decode the block of video data using the subsampling technique and the cross-component prediction mode, the one or more processors are further configured to: predict the chroma samples of the block using a prediction model for the cross-component prediction mode that uses a larger number of the luma samples relative to the chroma samples.

Aspect 24B—The apparatus of Aspect 23B, wherein the prediction model includes non-linear terms.

Aspect 25B—The apparatus of Aspect 23B, wherein the prediction model uses a 3×2 filter shape, and wherein to decode the block of video data using the subsampling technique and the cross-component prediction mode, the one or more processors are further configured to: predict one chroma sample of the block using the prediction model using the 3×2 filter shape and six luma samples.

Aspect 26B—The apparatus of Aspect 22B, wherein to determine to not apply subsampling to the luma samples of the block of video data, the one or more processors are further configured to: determine to not apply subsampling to the luma samples of the block of video data based on the video data being graphics content or screen content.

Aspect 27B—The apparatus of Aspect 21B, wherein to determine the subsampling technique, the one or more processors are further configured to: determine to apply a combination of downsampling filters to the luma samples of the block of video data.

Aspect 28B—The apparatus of Aspect 27B, wherein the one or more processors are further configured to: apply the combination of downsampling filters to the luma samples of the block of video data at multiple chroma sample positions in the block of video data.

Aspect 29B—The apparatus of Aspect 27B, wherein the one or more processors are further configured to: apply the combination of downsampling filters to the luma samples of the block of video data at particular chroma sample positions in the block of video data according to a constraint.

Aspect 30B—The apparatus of Aspect 27B, wherein to determine to apply the combination of downsampling filters to the luma samples of the block of video data, the one or more processors are further configured to: determine to apply the combination of downsampling filters, from among a plurality of combinations of downsampling filters, to the luma samples of the block of video data.

Aspect 31B—The apparatus of Aspect 27B, wherein to decode the block of video data using the subsampling technique and the cross-component prediction mode, the one or more processors are further configured to: apply the combination of downsampling filters to the luma samples of the block of video data to produce downsampled luma samples; and predict the chroma samples of the block using the downsampled luma samples as inputs to a prediction model having a prediction model shape.

Aspect 32B—The apparatus of Aspect 31B, wherein to apply the combination of downsampling filters to the luma samples of the block of video data to produce downsampled luma samples, the one or more processors are further configured to: apply the combination of downsampling filters to the luma samples of the block of video data at multiple chroma sample positions to produce downsampled luma samples.

Aspect 33B—The apparatus of Aspect 31B, wherein to apply the combination of downsampling filters to the luma samples of the block of video data to produce the downsampled luma samples, the one or more processors are further configured to: apply the combination of downsampling filters to the luma samples of the block of video data based on the prediction model shape to produce the downsampled luma samples.

Aspect 34B—The apparatus of Aspect 33B, wherein the combination of downsampling filters includes a plurality of 3×2 downsampling filters.

Aspect 35B—The apparatus of Aspect 33B, wherein the prediction model shape is a one-directional shape, a diamond 3×3 shape, a diamond 5×5 shape, a diamond 7×5 shape, or a shape that is larger in a horizontal direction than a vertical direction.

Aspect 36B—The apparatus of Aspect 31B, wherein the prediction model includes non-linear terms.

Aspect 37B—The apparatus of Aspect 21B, wherein to determine the subsampling technique, from the plurality of subsampling techniques, for the luma samples of the block of video data for the cross-component prediction mode, the one or more processors are further configured to: determine a cross-component model for the cross-component prediction mode; and determine the subsampling technique from the cross-component model for the cross-component prediction mode.

Aspect 38B—The apparatus of Aspect 37B, wherein to determine the cross-component model for the cross-component prediction mode, the one or more processors are further configured to: determine the cross-component model for the cross-component prediction mode from non-adjacent neighbor blocks of the block of video data.

Aspect 39B—The apparatus of any of Aspects 21B-28B, wherein to determine the subsampling technique, the one or more processors are further configured to: receive a syntax element that indicates the subsampling technique, wherein a first subsampling technique of the plurality of subsampling techniques includes not applying subsampling to the luma samples of the block of video data, and a second subsampling technique of the plurality of subsampling techniques includes a combination of downsampling filters to be applied to the luma samples of the block.

Aspect 40B—The apparatus of any of Aspects 21B-29B, wherein the cross-component prediction mode is one of local illumination compensation (LIC), chroma linear mode, cross-component linear mode (CCLM), multi-model LM (MMLM) mode, cross-component chroma inter prediction (CCCM), or gradient linear model (GLM).

Aspect 41B—A method of encoding video data, the method comprising: receiving a block of video data, wherein chroma samples of the block of video data are subsampled relative to luma samples of the block of video data; determining a subsampling technique, from a plurality of subsampling techniques, for the luma samples of the block of video data for a cross-component prediction mode; and encoding the block of video data using the subsampling technique and the cross-component prediction mode.

Aspect 42B—An apparatus configured to encode video data, the apparatus comprising: a memory; and one or more processors coupled to the memory, the one or more processors configured to: receive a block of video data, wherein chroma samples of the block of video data are subsampled relative to luma samples of the block of video data; determine a subsampling technique, from a plurality of subsampling techniques, for the luma samples of the block of video data for a cross-component prediction mode; and encode the block of video data using the subsampling technique and the cross-component prediction mode.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
receiving a block of video data, wherein chroma samples of the block of video data are subsampled relative to luma samples of the block of video data;
determining a subsampling technique, from a plurality of subsampling techniques, for the luma samples of the block of video data for a cross-component prediction mode; and
decoding the block of video data using the subsampling technique and the cross-component prediction mode.

2. The method of claim 1, wherein determining the subsampling technique comprises:
determining to not apply subsampling to the luma samples of the block of video data.

3. The method of claim 2, wherein decoding the block of video data using the subsampling technique and the cross-component prediction mode comprises:
predicting the chroma samples of the block using a prediction model for the cross-component prediction mode that uses a larger number of the luma samples relative to the chroma samples.

4. The method of claim 3, wherein the prediction model includes non-linear terms.

5. The method of claim 3, wherein the prediction model uses a 3×2 filter shape, and wherein decoding the block of video data using the subsampling technique and the cross-component prediction mode comprises:
predicting one chroma sample of the block using the prediction model using the 3×2 filter shape and six luma samples.

6. The method of claim 2, wherein determining to not apply subsampling to the luma samples of the block of video data comprises:
determining to not apply subsampling to the luma samples of the block of video data based on the video data being graphics content or screen content.

7. The method of claim 1, wherein determining the subsampling technique comprises:
determining to apply a combination of downsampling filters to the luma samples of the block of video data.

8. The method of claim 7, further comprising:
applying the combination of downsampling filters to the luma samples of the block of video data at multiple chroma sample positions in the block of video data.

9. The method of claim 7, further comprising:
applying the combination of downsampling filters to the luma samples of the block of video data at particular chroma sample positions in the block of video data according to a constraint.

10. The method of claim 7, wherein determining to apply the combination of downsampling filters to the luma samples of the block of video data comprises:
determining to apply the combination of downsampling filters, from among a plurality of combinations of downsampling filters, to the luma samples of the block of video data.

11. The method of claim 7, wherein decoding the block of video data using the subsampling technique and the cross-component prediction mode comprises:
applying the combination of downsampling filters to the luma samples of the block of video data to produce downsampled luma samples; and
predicting the chroma samples of the block using the downsampled luma samples as inputs to a prediction model having a prediction model shape.

12. The method of claim 11, wherein applying the combination of downsampling filters to the luma samples of the block of video data to produce downsampled luma samples comprises:
applying the combination of downsampling filters to the luma samples of the block of video data at multiple chroma sample positions to produce downsampled luma samples.

13. The method of claim 11, wherein applying the combination of downsampling filters to the luma samples of the block of video data to produce the downsampled luma samples comprises:
applying the combination of downsampling filters to the luma samples of the block of video data based on the prediction model shape to produce the downsampled luma samples.

14. The method of claim 13, wherein the combination of downsampling filters includes a plurality of 3×2 downsampling filters.

15. The method of claim 13, wherein the prediction model shape is a one-directional shape, a diamond 3×3 shape, a diamond 5×5 shape, a diamond 7×5 shape, or a shape that is larger in a horizontal direction than a vertical direction.

16. The method of claim 11, wherein the prediction model includes non-linear terms.

17. The method of claim 1, wherein determining the subsampling technique, from the plurality of subsampling techniques, for the luma samples of the block of video data for the cross-component prediction mode comprises:
determining a cross-component model for the cross-component prediction mode; and
determining the subsampling technique from the cross-component model for the cross-component prediction mode.

18. The method of claim 17, wherein determining the cross-component model for the cross-component prediction mode comprises:
determining the cross-component model for the cross-component prediction mode from non-adjacent neighbor blocks of the block of video data.

19. The method of claim 1, wherein determining the subsampling technique comprises:
receiving a syntax element that indicates the subsampling technique, wherein a first subsampling technique of the plurality of subsampling techniques includes not applying subsampling to the luma samples of the block of video data, and a second subsampling technique of the plurality of subsampling techniques includes a combination of downsampling filters to be applied to the luma samples of the block.

20. The method of claim 1, wherein the cross-component prediction mode is one of local illumination compensation (LIC), chroma linear mode, cross-component linear mode (CCLM), multi-model LM (MMLM) mode, cross-component chroma inter prediction (CCCM), or gradient linear model (GLM).

21. An apparatus configured to decode video data, the apparatus comprising:
a memory; and
one or more processors coupled to the memory, the one or more processors configured to:
receive a block of video data, wherein chroma samples of the block of video data are subsampled relative to luma samples of the block of video data;
determine a subsampling technique, from a plurality of subsampling techniques, for the luma samples of the block of video data for a cross-component prediction mode; and
decode the block of video data using the subsampling technique and the cross-component prediction mode.

22. The apparatus of claim 21, wherein to determine the subsampling technique, the one or more processors are further configured to:
determine to not apply subsampling to the luma samples of the block of video data.

23. The apparatus of claim 22, wherein to decode the block of video data using the subsampling technique and the cross-component prediction mode, the one or more processors are further configured to:
predict the chroma samples of the block using a prediction model for the cross-component prediction mode that uses a larger number of the luma samples relative to the chroma samples.

24. The apparatus of claim 23, wherein the prediction model includes non-linear terms.

25. The apparatus of claim 23, wherein the prediction model uses a 3×2 filter shape, and wherein to decode the block of video data using the subsampling technique and the cross-component prediction mode, the one or more processors are further configured to:
predict one chroma sample of the block using the prediction model using the 3×2 filter shape and six luma samples.

26. The apparatus of claim 22, wherein to determine to not apply subsampling to the luma samples of the block of video data, the one or more processors are further configured to:
determine to not apply subsampling to the luma samples of the block of video data based on the video data being graphics content or screen content.

27. The apparatus of claim 21, wherein to determine the subsampling technique, the one or more processors are further configured to:
determine to apply a combination of downsampling filters to the luma samples of the block of video data.

28. The apparatus of claim 27, wherein the one or more processors are further configured to:
apply the combination of downsampling filters to the luma samples of the block of video data at multiple chroma sample positions in the block of video data.

29. The apparatus of claim 27, wherein the one or more processors are further configured to:
apply the combination of downsampling filters to the luma samples of the block of video data at particular chroma sample positions in the block of video data according to a constraint.

30. The apparatus of claim 27, wherein to determine to apply the combination of downsampling filters to the luma samples of the block of video data, the one or more processors are further configured to:
determine to apply the combination of downsampling filters, from among a plurality of combinations of downsampling filters, to the luma samples of the block of video data.

31. The apparatus of claim 27, wherein to decode the block of video data using the subsampling technique and the cross-component prediction mode, the one or more processors are further configured to:
apply the combination of downsampling filters to the luma samples of the block of video data to produce downsampled luma samples; and
predict the chroma samples of the block using the downsampled luma samples as inputs to a prediction model having a prediction model shape.

32. The apparatus of claim 31, wherein to apply the combination of downsampling filters to the luma samples of the block of video data to produce downsampled luma samples, the one or more processors are further configured to:
apply the combination of downsampling filters to the luma samples of the block of video data at multiple chroma sample positions to produce downsampled luma samples.

33. The apparatus of claim 31, wherein to apply the combination of downsampling filters to the luma samples of the block of video data to produce the downsampled luma samples, the one or more processors are further configured to:
apply the combination of downsampling filters to the luma samples of the block of video data based on the prediction model shape to produce the downsampled luma samples.

34. The apparatus of claim 33, wherein the combination of downsampling filters includes a plurality of 3×2 downsampling filters.

35. The apparatus of claim 33, wherein the prediction model shape is a one-directional shape, a diamond 3×3 shape, a diamond 5×5 shape, a diamond 7×5 shape, or a shape that is larger in a horizontal direction than a vertical direction.

36. The apparatus of claim 31, wherein the prediction model includes non-linear terms.

37. The apparatus of claim 21, wherein to determine the subsampling technique, from the plurality of subsampling techniques, for the luma samples of the block of video data for the cross-component prediction mode, the one or more processors are further configured to:
determine a cross-component model for the cross-component prediction mode; and
determine the subsampling technique from the cross-component model for the cross-component prediction mode.

38. The apparatus of claim 37, wherein to determine the cross-component model for the cross-component prediction mode, the one or more processors are further configured to:
determine the cross-component model for the cross-component prediction mode from non-adjacent neighbor blocks of the block of video data.

39. The apparatus of claim 21, wherein to determine the subsampling technique, the one or more processors are further configured to:
receive a syntax element that indicates the subsampling technique, wherein a first subsampling technique of the plurality of subsampling techniques includes not applying subsampling to the luma samples of the block of video data, and a second subsampling technique of the plurality of subsampling techniques includes a combination of downsampling filters to be applied to the luma samples of the block.

40. The apparatus of claim 21, wherein the cross-component prediction mode is one of local illumination compensation (LIC), chroma linear mode, cross-component linear mode (CCLM), multi-model LM (MMLM) mode, cross-component chroma inter prediction (CCCM), or gradient linear model (GLM).

41. A method of encoding video data, the method comprising:
receiving a block of video data, wherein chroma samples of the block of video data are subsampled relative to luma samples of the block of video data;
determining a subsampling technique, from a plurality of subsampling techniques, for the luma samples of the block of video data for a cross-component prediction mode; and
encoding the block of video data using the subsampling technique and the cross-component prediction mode.

42. An apparatus configured to encode video data, the apparatus comprising:
a memory; and
one or more processors coupled to the memory, the one or more processors configured to:
receive a block of video data, wherein chroma samples of the block of video data are subsampled relative to luma samples of the block of video data;
determine a subsampling technique, from a plurality of subsampling techniques, for the luma samples of the block of video data for a cross-component prediction mode; and
encode the block of video data using the subsampling technique and the cross-component prediction mode.
